(19) United States
(12) Patent Application Publication
(10) Pub. No.: US 2006/0207366 A1
(43) Pub. Date: Sep. 21, 2006

(54) Device Having Multiple Driving Arms Rotated Circularly Without Axial Rotation and the Method of the Same

(76) Inventor: Mehmet Salih Atak, Izmir (TR)

Correspondence Address: Luis M Ortiz;ORTIZ & LOPEZ, Post Office Box 4484, Albuquerque, NM, 87196-4484, US

(21) Appl. No.: 10/561,492

(22) PCT Filed: Jun. 17, 2004
(86) PCT No.: PCT/TR04/00033

§ 371 Date: Dec. 16, 2005

(30) Foreign Application Priority Data
Jun. 17, 2003 (TR) 2003/00903
Jun. 15, 2004 (TR) 2004/01403

(51) Int. Cl. F16H 35/00

(52) U.S. Cl. 74/380

(57) ABSTRACT

The present invention relates to a mechanism comprising a number of spindles capable to perform circular motion without an axial rotation drive; and more particularly to a mechanism, which is capable to perform operations such as cleaning, brushing, cutting, boring, abrading, etc. on even or uneven surfaces by means of auxiliary units supplied on terminus of such spindles, and where fluid supply can be made externally for such terminal units.

### TECHNICAL FIELD

The present invention relates to a mechanism comprising a number of spindles capable to perform circular motion without an axial rotation drive; and more particularly to a mechanism, which is capable to perform operations such as orienting, brushing, cutting, boring, abrading, etc. on even or uneven surfaces by means of auxiliary units supplied on terminus of such spindles, and where fluid supply can be made externally for such terminal units.

The preferred application field of the present invention comprises cleaning-purpose manufacturing devices and manufacturing devices based on machining, along with variation operations in production stages such as assembly, surface polishing, finishing, etc.

### BACKGROUND OF INVENTION

The mechanism under the present invention relates to a mechanism, which comprises a number of spindles, and which can make a circular motion without an axial rotation drive. Such a drive-producing mechanism can be applied in a number of fields such as cleaning machines, soil processing machines, construction applications, solid and fluid material orienting operations, metal piece machining, etc. Particularly multispindle embodiments are known as close to this technical field.

Specifically in the machining field, various solutions have already been offered comprising multispindles and machining a number of pieces at the same time. The U.S. Pat. No. 4,608,747 , for example, discloses a multispindle automatic turret lathe defining a number of operative spindles rotationally connected to a central axis.

The U.S. Pat. No. 4,008,634 discloses a lathe comprising a movable arm mechanism with a number of spindles.

These aforesaid patents are given with illustrative purposes only, and there are also various work and machining means present such as millers, grinders, borers, etc. where such multispindle mechanism is employed.

Although providing advantages in distributing the rotational drive from a single centered power supply and allowing works be performed simultaneously on different stations, such mechanisms have also some disadvantages. In such mentioned patents, for example, the drive as taken from a central power unit is transferred to a number of spindles and workpieces located on the terminus of such axially moving spindles are machined by a cutting tip.

Similar drives are employed also in equipment such as milling and drilling machines, and since such cutting tip is located on the terminal of such a spindle, centrally-driven spindles also realize axial cutting operations. In addition to the disadvantages that the tools operating on the terminus of such spindles become worn and/or defected in relatively shorter period of times and operate undesirably due to the permanent axial rotation, it is unavoidable that such tools are applied on uneven surfaces and that supplying fluids to such terminus involves structures requiring complex and expensive solutions. Also such mechanisms with axial drives lead to circumstances where operative functions of drive spindles cannot be utilized in applications with structural restrictions.

Once the cleaning mechanisms are assessed as a specific field of the embodiment under the present invention, the mechanical structures of the supportive constructions and construction drives of current vehicle washing machines and rim brushes, vertical brushes and horizontal brushes employed therein are expensive due to their centrifugal influences, consume relatively more chemical, water, and energy, expose technical drawbacks in reaching such brushes to the hollow-like formations of surfaces; the preliminary cleaning operations cannot be done adequately or high fluid rates are required because of the huge number of spraying nipples, the drying units are inefficient, tunnels and streets where each such operation unit performing serial wash are arranged successively and vehicles are moved require long areas, and brushes with their tips spoiled requires replacement and expose high costs.

### BRIEF DESCRIPTION OF INVENTION

The objective of the present invention is to enhance operational output in applications such as all types of cleaning, soil processing, building construction applications, solid and fluid material orienting or machining by making accessible the regions with non-axial circular motion, where directly axially rotating terminal units cannot reach.

Another objective of the present invention is to lengthen the wear-out period of terminal units, which are operative in manufacture based production means.

A further objective of the present invention is to prevent any damages to rise from thermal expansions of terminal units and machined pieces in production means based on machining.

Yet a further objective of the present invention is to lower the costs of even, uneven, and difficulty-machined pieces by enhancing their machining output.

The present invention comprises a main drive spindle, which is driven by a power supply and can rotate axially; at least one eccentric element, which is in communication with said drive spindle and produce eccentric motion; at least one bearing means surrounding this eccentric element; and at least one drive transmitting element of which one terminal is connected to said eccentric bearing means and the other terminal to a final drive spindle.

The circular rotation of the final drive spindle of the multispindle mechanism without axial rotation and with circular rotation under the present invention comprises preferably an elliptic formation. As a result of said elliptic motion, the terminal of the final drive spindle remains within an orbit plane and the present mechanism displaces on the axial direction of the final drive spindle in order to carry the motion to other planes except the former plane.

Thus the rotation coming from the main drive spindle with axial motion is turned into an elliptic-based circular motion on the final drive spindle in order to allow the operative terminal unit to reach to various recessed/projected regions, to prevent it from continuous abrasion forces in the manufacturing field, and to provide a simple access route for the fluid path of an external fluid to be delivered to the terminal unit.

An alternative embodiment of the present invention comprises a main drive spindle, which is driven by a power supply and makes an axial rotation; at least one eccentric element, which is in connection with said main drive spindle and produces eccentric motion; at least one bearing means surrounding this eccentric element; at least one primary drive transmitting element of which one end is connected to this bearing means and the other to a primary plate and at least one secondary drive transmitting element connected to a secondary plate; and at least one final drive spindle, which is supported movably (or flexibly) by said primary plate and said secondary plate.

The circular rotation of the final drive spindle of the multispindle mechanism without axial rotation and with circular rotation under the present invention comprises preferably an elliptic formation. The elliptic motion of the final drive spindle is associated with said plate's motion and said plates can move in various ways such as in an independent manner from each other or with one plate driven and the other plate connected to said driven plate in an ellipsoid or movable (or flexible) character. The drive variations between said plates are described below under the detailed description.

Once the cleaning mechanisms are assessed as a specific field of the embodiment under the present invention, and when such cleaning operation is performed by an ellipsoid brushing method, the brushes reach the recessed regions on the vehicle's periphery and rim surface, and washing, rinsing, and sliding fluids are supplied directly to such brushes and vehicle surface. When the structure is formed from thermoplastic materials in general, heavy constructions and dispatching units are not necessitated. It becomes possible to apply special chemicals and mechanical operations to some standardized regions on vehicles such as rims, mirrors, headlights, mudguards, etc. with respect to their locations on such vehicle and to perform preliminary cleaning with pressurized fluids before brushing. By equipping pressurized water spraying units and brushing units with distance and sound sensors, and by analyzing the date as received from such sensors, the vehicle's periphery can be determined and the back units to clean such vehicle can be positioned for regional cleaning operations; fluids can be absorbed by fibrous sponge-like materials and suckers to be fastened thereto that can transfer the rinsing water and right after water to the section after brushing; and the drying operation can be efficiently performed by moving on the width of such vehicle sliding fluid sprayer and pressurized air spraying unit to be fastened to a linear driver. By fastening fiber-felt like materials to said final spindles in place of brushes, heat can be formed on the vehicle's surface as a result of applying mechanical energy on said surface to complete surface polishing operations. Swift and regional brush changing operations with swiftly replaced brushes can be realized economically.

### DESCRIPTION OF FIGURES

The embodiment and advantages of the present invention shall be made clear with the figures described as following and the present invention is to be evaluated by taking into account such descriptions.

FIG. 1 gives a perspective view of a preferable drive mechanism under the present invention.

FIG. 2a gives a view of the drive transmitting element and associated bearing of the drive mechanism under the present invention.

FIG. 2b shows the orbit followed by the main drive and final spindle when the drive transmitting element support of the drive mechanism under the present invention is in the exact central position.

FIG. 2c shows the orbit followed by the main drive and final spindle when the drive transmitting element support of the drive mechanism under the present invention is close to the drive spindle.

FIG. 2d shows the orbit followed by the main drive and final spindle when the drive transmitting element support of the drive mechanism under the present invention is far from the drive spindle.

FIG. 3a gives a perspective view of a preferable drive mechanism under the present invention together with the drive transmitting parts.

FIG. 3b shows the orbit followed by the final drive spindle of the drive mechanism under the present invention when said final drive spindle is fastened from its lower end to the main frame.

FIG. 3c shows the orbit followed by the final drive spindle of the drive mechanism under the present invention when said final drive spindle is fastened from its lower center.

FIG. 3d shows the orbit followed by the final drive spindle of the drive mechanism under the present invention when said final drive spindle is free.

FIG. 4 shows the stable position of the mechanism providing the axial displacement of the drive mechanism under the present invention.

FIG. 4b shows the displaced position of the mechanism providing the axial displacement of the drive mechanism under the present invention.

FIG. 5 shows an alternative of the mechanism providing the axial displacement of the drive mechanism under the present invention.

FIG. 6 shows an alternative of the mechanism providing the axial displacement of the drive mechanism under the present invention.

FIG. 7 shows an alternative of the mechanism providing the axial displacement of the drive mechanism under the present invention.

FIG. 8 shows an alternative of the mechanism providing the axial displacement of the drive mechanism under the present invention.

FIG. 9 shows an alternative of the mechanism providing the axial displacement of the drive mechanism under the present invention.

FIG. 10 shows an alternative of the mechanism providing the axial displacement of the drive mechanism under the present invention.

FIG. 11 gives a mechanism showing the multi structured operation of the drive mechanism under the present invention.

FIG. 12 gives an adaptor piece providing the operation of the terminal unit of the final drive spindle of the drive mechanism under the present invention.

FIG. 13 gives the terminal unit of the final drive spindle of the drive mechanism under the present invention.

FIG. 14 gives the extra final drive spindle of the drive mechanism under the present invention.

FIG. 15 gives an alternative embodiment of the drive mechanism under the present invention together with the final multispindle group.

FIG. 16 gives an alternative embodiment of the drive mechanism under the present invention together with the final multispindle group.

FIG. 17 gives an alternative embodiment comprising a multi eccentric element under the present invention.

FIG. 18 shows the delivery of fluid liquid to the terminal unit of the final drive spindle of the drive mechanism under the present invention.

FIG. 19 gives a perspective view of a preferred embodiment mechanism comprising the double-plate multi final drive spindle under the present invention.

FIG. 20a gives a perspective view of a preferred alternative embodiment mechanism comprising the double-plate multi final drive spindle under the present invention.

FIG. 20bgives the bearing detail with an ellipsoid structure which can rotate externally under the arrangement as given under FIG. 20a.

FIG. 20c gives the axial rotating bearing detail under the arrangement as given under FIG. 20a.

FIG. 21 gives a perspective view of an alternative embodiment of the mechanism comprising said double-plate multi final drive spindle under the present invention.

FIG. 22 shows the sinusoidal and pulse wide modulation control manners during the T time of 360 degrees eccentric rotation applied to the control element of the primary match actuator group positioned 180 degrees against the mechanism given under FIG. 21.

FIG. 23 shows the pressure differences during the equivalent T time formed on actuators positioned mutually 180 degrees as a result of the control given under FIG. 22.

FIG. 24 shows the sinusoidal and pulse wide modulation control manners during the T time of 360 degrees eccentric rotation applied to control elements of the secondary counterpart actuator group positioned with a 90 degrees difference with the mutually matched actuators of the mechanism given under FIG. 21.

FIG. 25 shows the pressure differences during the equivalent T time formed on the secondary matched actuator positioned mutually 180 degrees as a result of the control given under FIG. 24.

FIG. 26 shows the angular positioning of 4 actuators by synchronized control with respect to the eccentric bearing's center during the T time.

FIG. 27 gives a perspective view of an alternative embodiment of the mechanism comprising the double plate multi final drive spindle under the present invention.

FIG. 28a gives the view of the motion orbit corresponding to the case where said flexible connection element is not present in ellipsoid bearing in the mechanism in FIG. 27.

FIG. 28b gives the view of the motion orbit corresponding to the case of an alternative mechanism of FIGS. 19-22.

FIG. 28c gives the view of the variation motion orbit of the mechanism of FIG. 19.

FIG. 28d gives the view of the motion orbit corresponding to an alternative state of FIG. 27, where flexible connection elements are present on the mechanism.

FIG. 29 gives a perspective view of an alternative structure of a mechanism comprising the double plate multispindle under the present invention.

FIG. 30 gives the view of the fluid transferring assembly of the mechanism comprising the double plate multispindle under the present invention.

FIG. 31 gives a view of an embodiment formed for cleaning purposes by employing the mechanism comprising the double plate multispindle under the present invention.

FIG. 32 gives a view of an embodiment formed for cleaning purposes by employing the mechanism comprising the double plate multispindle under the present invention.

FIG. 33 gives a view of an embodiment formed for cleaning purposes by employing the mechanism comprising the double plate multispindle under the present invention.

### DETALLED DESCRIPTION OF INVENTION

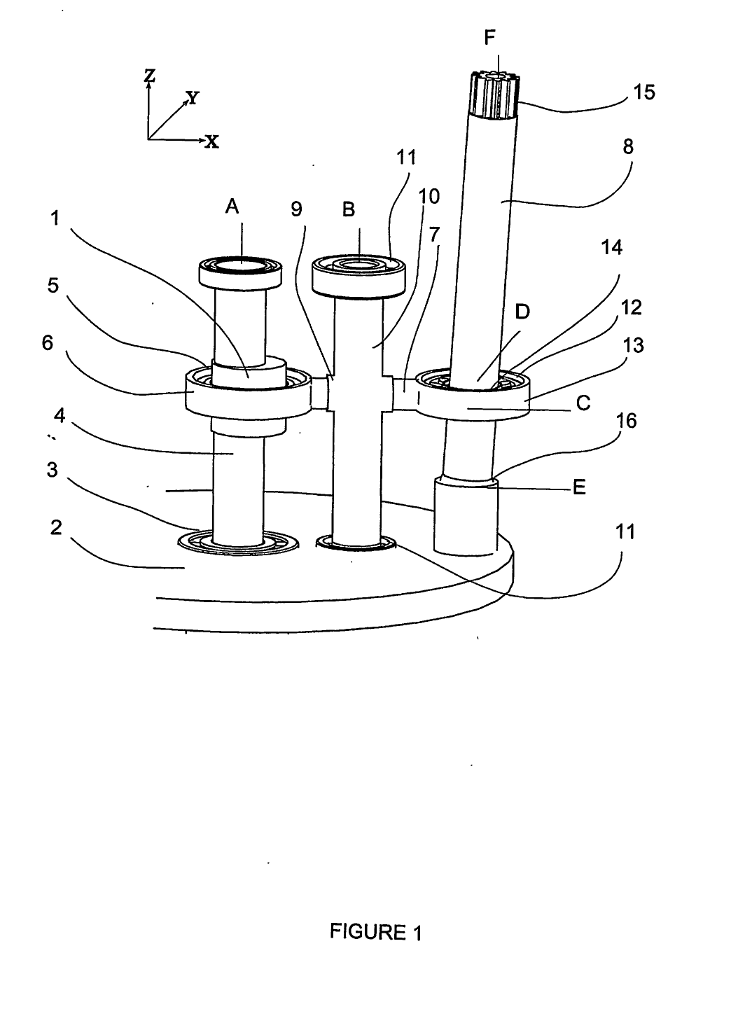

As seen from FIG. 1, a main drive spindle (4) is present having an axial rotation on the center and supported by the main frame (2) by means of the main frame bearing (3) composed of eccentric elements (1) in a sufficient number. The main drive rotational bearing (5) is assembled to said eccentric element (1). By the rotation of the main drive spindle (4), a circular motion is obtained on the outer support (6) of rotational eccentric bearings (5). The objective under the present invention is to transfer such circular motion to the terminal units (15).

Such motion transfer is performed by two drive bars, namely one drive transferring spindle (7) and one final drive spindle (8). The number of terminal units can be increased by connecting more than one final spindle to a single drive transferring spindle. Each drive transferring spindle (7) has three connection points, whereby such drive is received, supported to the frame, and such drive is transferred.

The point that such drive is received is the point that is leaned on the eccentric part close to the center of the drive transferring spindle (7). The drive transferring spindle (7) is connected to the outer support of the rotational eccentric bearing (6) so as to become essentially vertical with respect to the bearing's axis or this bearing is manufactured on the tip of this spindle (7) as an integral part. Center A of the circular motion is on the axis (A) of the main drive spindle (4).

A drive transferring spindle bearing (9) is provided where said drive transferring shaft (7) is slid axially and this bearing (9) is included in a support piece (10) of which both ends are connected to the frame by one apiece rotational bearings (11) having parallel axes with respect to the main drive spindle (4). When the drive transferring spindle bearing (9) preferably in a straight form is also movable, the support piece is fastened by both ends to the frame. Thus when the drive transferring spindle (7) moves axially within this drive transferring spindle bearing (9), it also moves circularly. The rotational bearing center (B) of the support piece is the supportive point (B) of the drive transferring spindle.

The drive transferring spindle (7) is connectable in a radial manner to the outer support of the final spindle bearing of the final spindle rotational bearing (12) or this bearing is manufactured on the tip of this bar as an integral part and the central point (C) of this bearing, is the point C where the drive is transferred. The final transferring spindle (8) is connected to the inner surface (14) of this bearing (12). This connection point can be optionally connected to the final drive spindle (8) also without the use of a bearing. In all cases, it is the point D on the final spindle where the drive is transferred. The point (F) where the drive is transferred shall be the end of the final drive spindle (8) that is far from the main frame (2) and a connection part with a stable or movable bearing (15) is provided there where workpieces can be assembled. The end (E) of the final drive spindle (8) that is close to the main frame is point E and a movable bearing (16) is provided there that connects the spindle (8) to the main frame (2).

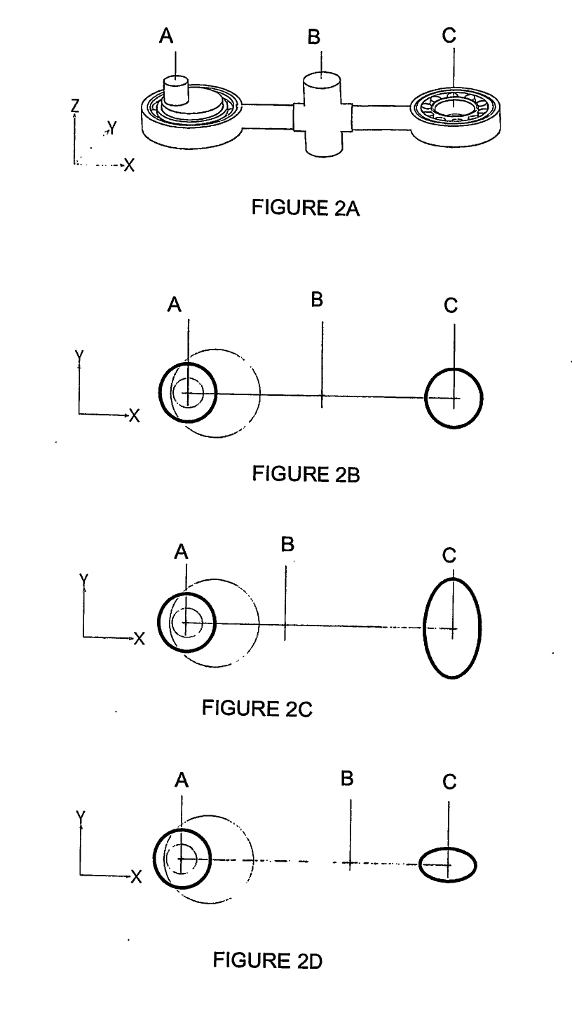

In group 2 figures, different operative modes are disclosed for the drive transferring spindle (7). Three movement points of the drive transferring spindle are pictured in FIG. 2b. It is only possible to transfer the rotational motion received on point A to point C in the same style and scale, if point B is exactly on the middle of points A and C. But it is also possible to transfer the rotational motion on point A to point C in an elliptical style. When the support center is closer to point A as compared to point C (FIG. 2c), an elliptical motion is obtained that has the vertical diameter larger on point C as compared to point A in the direction of the drive transfer, and when the support center is closer to point C as compared to point A (FIG. 2d), an elliptical motion is obtained that has the vertical diameter smaller on point C as compared to point A in the direction of such drive transfer. The diameter on the same direction is kept constant as twice the distance of the eccentric part's axis and the main spindle's axis.

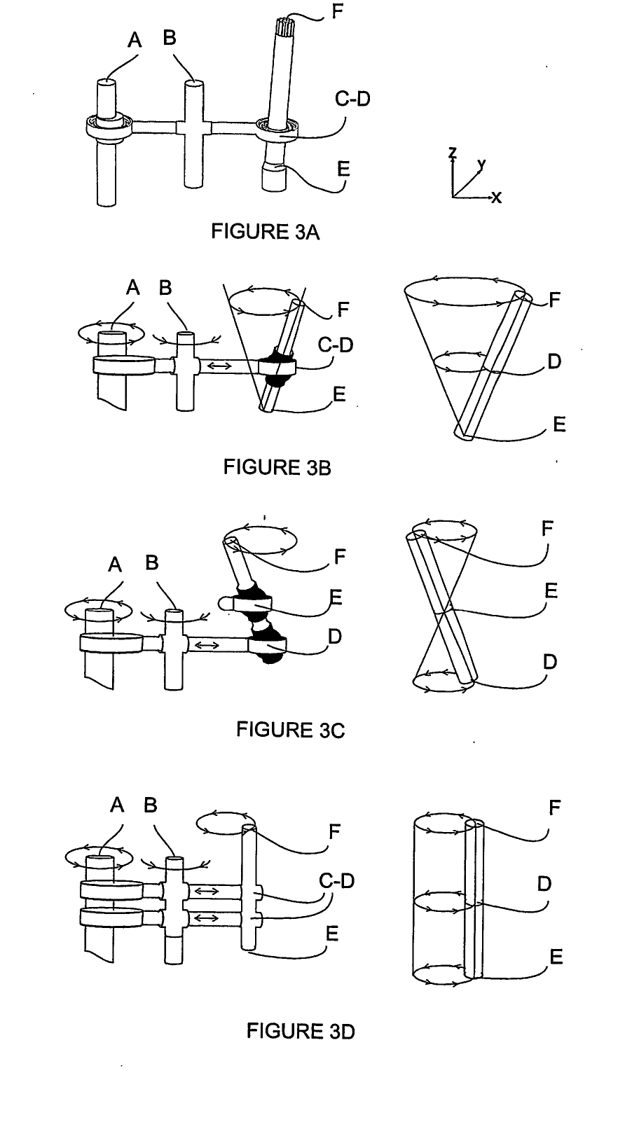

In group 3 figures, various operative modes of the final spindle are disclosed. The is end of the final drive spindle close to the main frame is selected as the support point and the related connections are marked (FIG. 3a). However, the final drive spindle's end that is close to the main frame as the drive receiving point can be selected as the support point in a region between the two ends of the final drive spindle by reversing the point where the drive is received with the support point and the end far from the frame can also be used as the point where such drive is transferred. Different operative modes can be obtained by reversing the support points and the points where drive is received, by embodying the connection points on these points movably or stably, and by using multiple secondary drive bars. When a movable bearing is used, one point of the bar is to be fastened jointly to the frame. In such circumstance, the final drive spindle (8) (FIGS. 3a and 3b) follows the outer surface of the circular-elliptic conic. When point E becomes the lower end (FIG. 3b) or the middle end of the bar (FIG. 3b), point F repeats the motion of point D by making it larger in proportion with the distances to point E.

When alternatively the point D where the drive is received is embodied stably or straightly sliding without axial rotation (FIG. 3d), the drive received from this point is equally transferred to the end point F and point E of the final drive spindle. In this case will point E also be movable. In order to meet lateral and vertical loads to be possibly received by the final drive spindle, an extra drive transferring spindle connected to the eccentric bearing from a second axis with an angle equal to the eccentric bearing of the drive transferring spindle at the main drive spindle can be passed through the straight sliding bearing at proper coordinates of the same supporting piece and be connected to the final spindle at a proper coordinate. In order to transfer the loads receivable from the z axis (vertical axis) to the main frame, a sliding or rotating bearing can be added between the supporting point of the final spindle and the main frame.

In addition to the aforesaid connection options, such spindles can be moved on the z axis (vertical axis) and different operative opportunities can be formed.

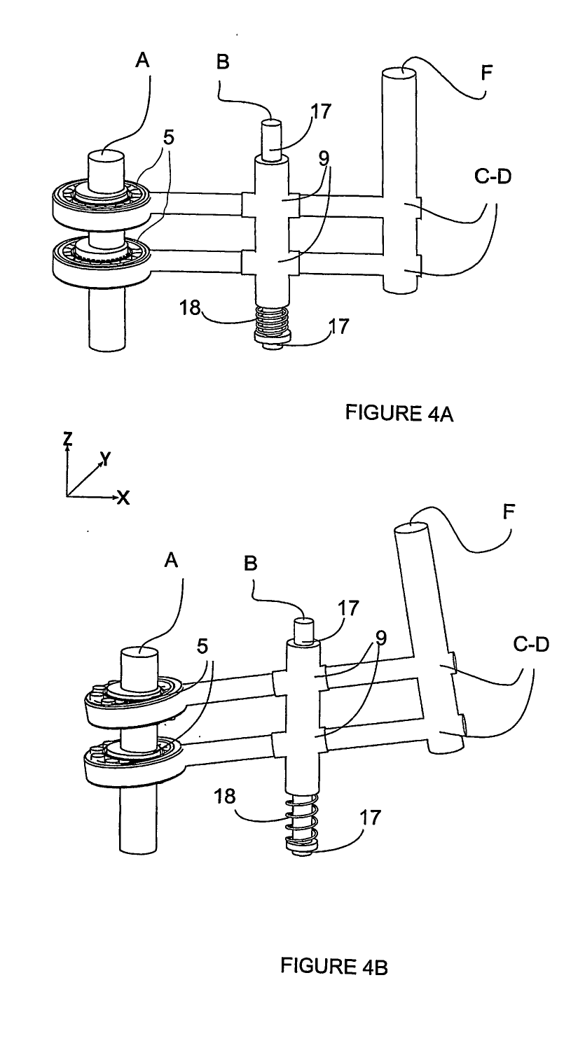

The final drive spindle (8) can be moved together with drive transferring spindle (7) on the z axis as in the group of FIGS. 4. For this to happen, the main drive rotating bearing (5) on point A and the drive transferring spindle bearings (9) on point B must be of joint type, and the rotating bearings on both sides of the supporting piece must be a rotating supporting piece bearing (17) where the supporting piece can move on vertically during rotating. The main drive rotating bearing (5) can be rotated on a radial direction with respect to the longitudinal axis of the main drive spindle (4). This movement is ensured with a spring (18). When the connections on point C and D are fixed, the final drive spindle (8) can move on a circular z axis with the center at point A within the movement limits of the z axis bearings of the supporting piece at point B.

The final drive spindle (8) can also be moved independently from the drive transferring spindle (7) at z axis.

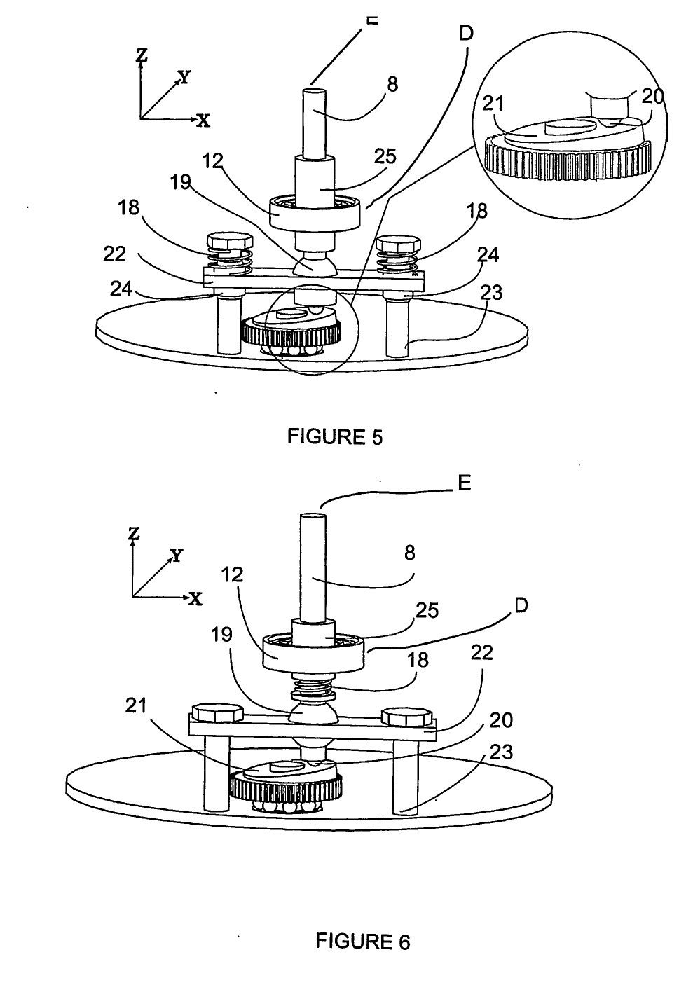

Regarding FIG. 5, a bearing with a final spindle joint (19) structure at point E and the bearings lower end (20) with a cylindrical spherical formation where the lower end of this bearing is in contact can be moved on the z axis by contacting a sopped platform (21) provided rotating to the main frame (2), to allow the final drive spindle (8) move on the z axis. In this circumstance, the support (22) is assembled to the frame (23) by means of support bearings (24) and is pushed to the sloped platform's surface (21) with spring (18) force. The final spindle rotating bearing (12) at point D must have a straight sliding bearing (25) wherein the final drive spindle (8) can also move axially.

In an alternative embodiment in FIG. 6, a straight form supporting bearing with a final spindle joint (19) at point E wherein the final drive spindle (8) can move axially together with its support (22) are fixed to the frame (23), and are moved at z axis together with the rotating sloped platform (21) where its lower end (20) projecting from this bearing is contacted. In this case, the final spindle rotating bearing (12) at point D, must have a straight sliding bearing (25), wherein the final drive spindle (8) can also axially move, and the spindle is pushed from the surface (21) of the sloped platform (21) with the spring (18) between bearing D and the spindle. The rotating sloped platform (21) can receive the drive movement from an actuator or from the main drive spindle. By synchronizing the z axis motion with the rotation of the main drive spindle, restraining forces and arm lengths from the differences as a result of momentum created on different points of the orbits of rotating parts on is the frame can be compensated and unwanted vibrations on the frame be reduced.

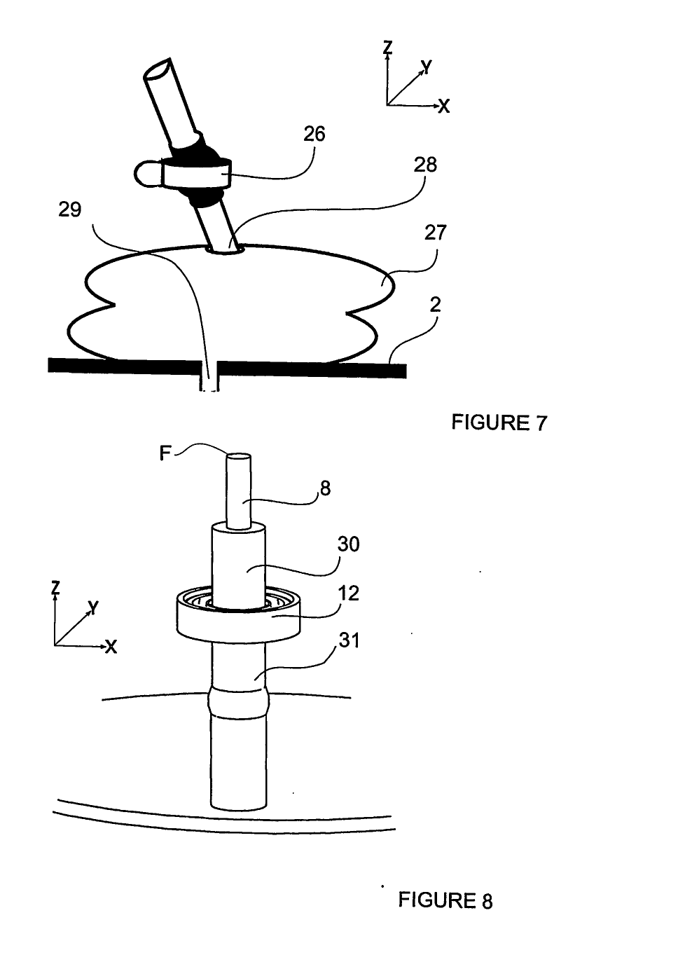

A flexible tube (27) is fastened between the frame (2) and the supporting bearing (26) in place of the rotating sloped platform (21) at point E, as shown in FIG. 7. The lower end of the final drive spindle (8) project6ing from the supporting bearing is connected to this tube (27). The tube is expanded as a result of applying pressurized air through its air inlet (29) and so it pushes the final drive spindle on the z axis. The movement of the lower end of final drive spindle (8) on coordinates x-y is absorbed by means of the flexibility of said tube (27). By controlling the pressure of such applied air, the pressure intensity to be applied to the work piece shall also be adjustable. By connecting such applied air transfer lines in common, they can be moved in common.

It is possible to make the movement on the z axis (horizontal axis) with a linear actuator, as seen in FIG. 8. When the self-bearing linear actuator (30) is connected by its frame to the points on the final spindle rotating bearing (12) where support (31) and drive is received, the shaft of the actuator shall operate as the drive spindle (8) and the tip of the spindle shall become point F.

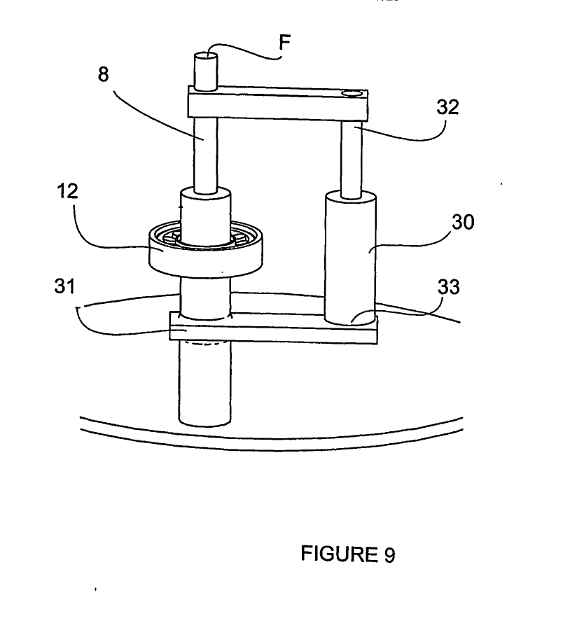

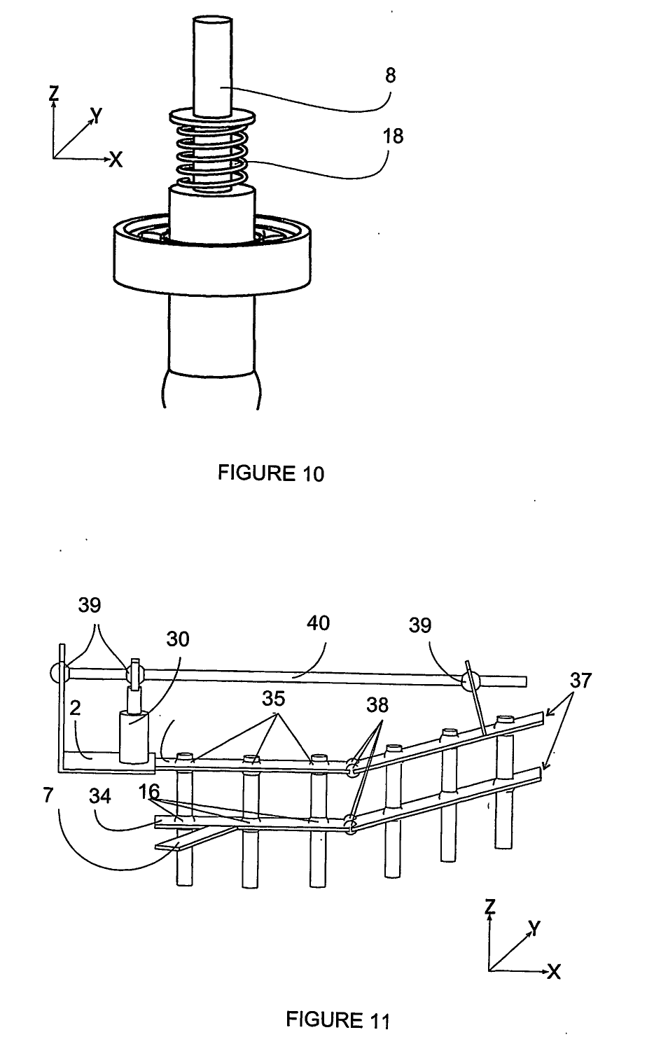

In an alternative embodiment in FIG. 9, the supporting (31) bearing and the final spindle rotating bearing (12) where such drive is received are embodied with straight sliding bearings and the terminal of a linear actuator (30) shaft (32) is connected to a region close to point F of the final drive spindle within these bearings. This actuator is connected to the supporting (31) bearing from the lower part (33) of its frame. By moving the actuator spindle on the x axis, the final drive spindle (8) shall too move on the z axis. When the straight actuators moving the drive shafts on the z axis are fed with air pressure, the pressure intensity applied to work pieces can be adjusted by controlling the air pressure driving such actuators. By connecting in common the air transfer lines with other actuators, they are moved in common or by employing a pushing spring (8) as seen in FIG. 10 in place of the linear actuator, the final drive spindle (8) is pushed with a fixed pressing force.

As seen in FIG. 11, by lengthening the connection element (34) whereby the drive is transferred from point C of the drive transferring spindle (1) to point D of the final drive spindle (8) and by fastening a multiple final drive spindle (8) to movable bearings (16), the capacity in increased. Also the frame element (36) is lengthened where the movable supporting bearings of final drive spindles (8) are assembled and is positioned parallel to the connection element to form a group. By connecting another group (37) to such capacity-enhanced group by means of group joints (38), a group is operated different on the z axis with respect to an adjacent group. Between the support of the extra group (37) far from the frame and the frame (2) is provided a shaft (40) connected with straight bearings and bar joint (39). The bearings of the connection shaft must be constructed so that to allow this shaft to move on the z axis, but not permit to change its projection direction on the xy plane. By a linear actuator (30) to be connected to a proper region of the frame and support piece or connection element, the extra group (37) is moved on the z axis. When such straight actuators are operated with pressurized air, the pressure intensity applied to workpieces can be adjusted by controlling the pressure of the air driving these actuators. By synchronizing such applied air transmission lines with the other actuators, they can be driven in common.

When the bearings on points E and D are jointed, the center of the movement at point F is dynamically altered by moving the bearing at point E in the primary drive spindle's direction and not on the lateral direction. By moving bearing E on the z axis, the movement on point F is dynamically made larger or smaller.

The center of the movement at point F can be simultaneously altered at both centers by assembling the E bearing to one end of a drive spindle of which the other end is supported by the frame, and by moving this spindle from its middle points on the z axis. These connection spindle and bearings must be constructed so that they shall permit this spindle to move on the z axis, but not permit to change its projection direction on the xy plane. The movement of this spindle on the z axis can be realized by a linear actuator or be moved in proportion of the distance to the work piece with a piece contacting thereto.

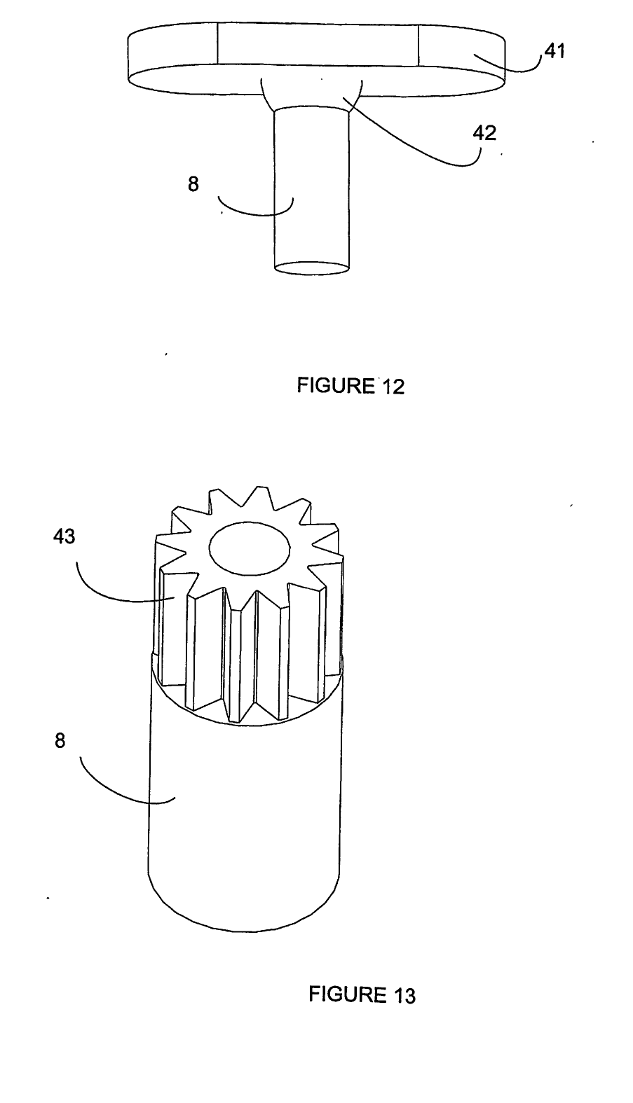

It is possible to connect the operative terminal units by means of fixed or jointed bearings at the terminal of the final drive spindles (8) at point F. The adaptor support (41) where the operative terminal units can be connected to, as seen in FIG. 12, is connected to the end of the final drive spindle (8) with a jointed bearing (42), and thus the operative part can be positioned parallel to the surface of the work piece. In order to prevent the adaptor support from rotating relative to the spindle's center, this adaptor support is assembled to a key channel (43) or threads embodied on the terminal of the final drive spindle (8), as demonstrated in FIG. 13.

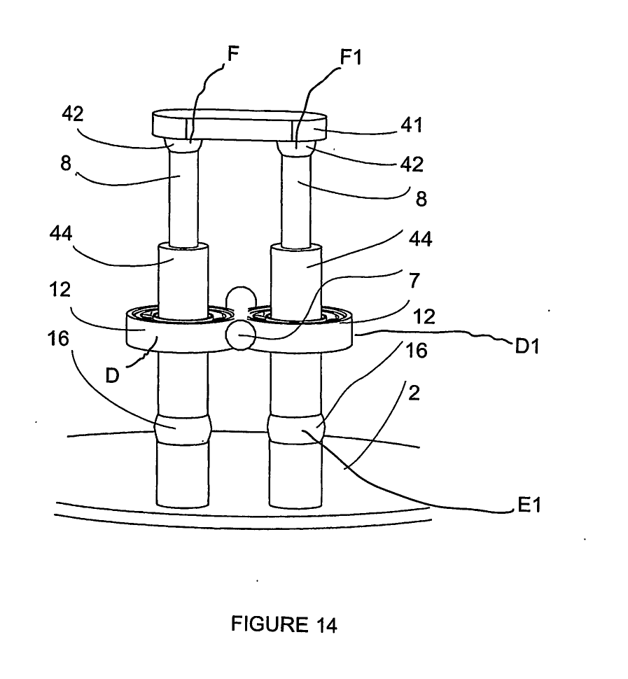

Regarding FIG. 14, both features are formed in a different embodiment. The final drive spindle (8) can rotate in the straight bearings (44) at movable bearings (16), which are fastened for the movement on the z axis and whereby the drive is received (D) and the spindle is supported. When the rotation is prevented by connecting spindle rotation bearing (12) to the drive transferring spindle (7) and connecting movable bearing (16) to the main frame (2), jointed bearings (42) are arranged to F1 and F2 points. The adapter piece (41) is assembled to these bearings. Thus the rotation of an operative piece around the final drive spindle (8) is prevented. By adjusting both drive spindles at different elevations relative to each other, the operative terminal unit conforms perfectly to the surface of a processed piece.

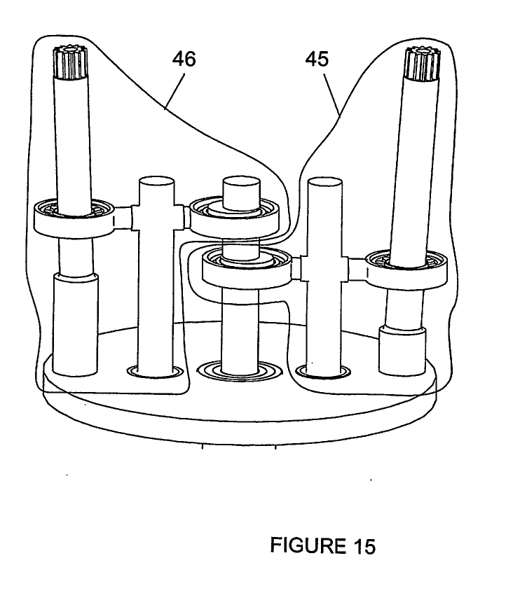

When a primary spindle group (45) is formed according to the work under FIG. 15 with the foregoing alternatives and once a double group is formed by assembling a second spindle group (46) on the symmetry of this group (45) with respect to its center of movement in identical conditions, the centripetal forces created by such opposite spindles is eliminated. The rotation moment in this condition, however, can be continued on the frame.

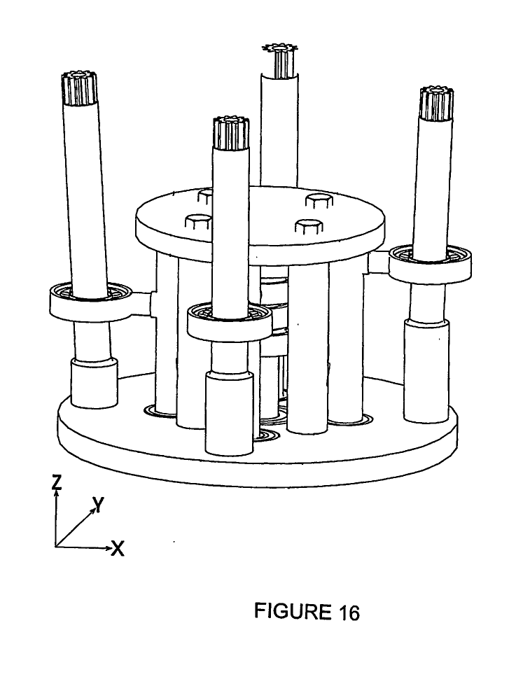

This circumstance, as seen in FIG. 16, can be prevented by adding a spindle pair that shall perform the operations of the first spindle pair reversely. In this circumstance, the spindle numbers must be 4 or its multiples. When the final terminal units are positioned on a circular arrangement with respect to the center, the relative angles between them must be 90°. Regarding the mechanisms which are not circular or which have their capacities enhanced with multiple spindles, the angular differences are formed so as to minimize the centripetal forces and moments.

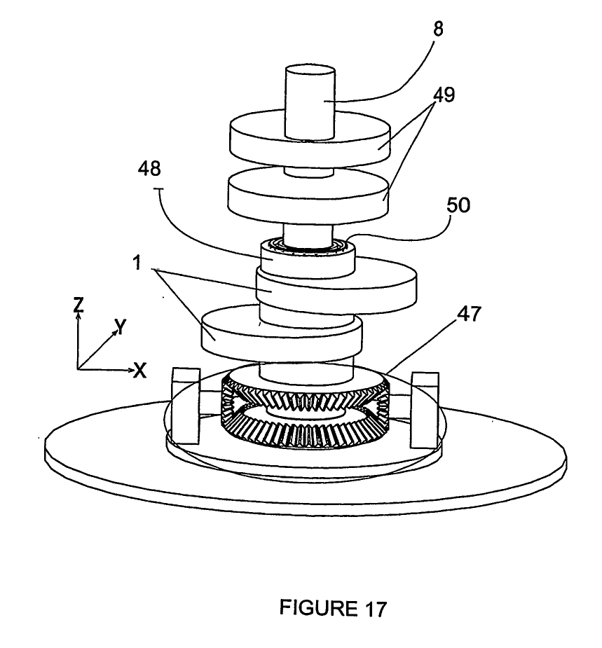

As the diameter of the circular motion at points F is increased, the efficiency of eliminating the aforesaid moments and centripetal forces shall decrease. By contrasting the eccentric revolutions of each spindle pairs, the centripetal forces are eliminated relatively better. As seen in FIG. 17, the rotation at the main drive spindle (8) is transferred to the other spindle by a gear assembly (47) and thus the contrary revolution obtained. Thus the second spindle (48) and eccentric elements (1) are revolved reversely and in synchrony with respect to the main drive spindle (8) and eccentric elements (1). The second spindle (48) can share the same axis by getting coupled to the main drive spindle (8) by means of rotating bearings (intermediary bearing). It is also possible to position it on a different axis, provided that spindles with enhanced capacities are employed.

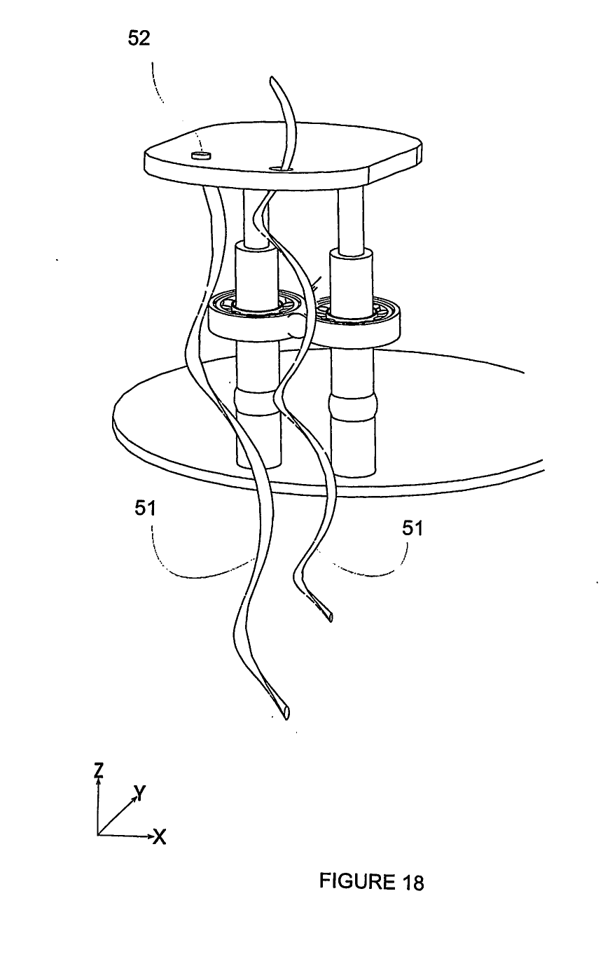

As seen in FIG. 18, it is possible to transfer two or more different fluids to the workpieces at point F by means of flexible hoses. These flexible hoses (51) are connected to the adapter support at point F or are passed through the pipe inlet (52) to be connected directly to operative terminal units.

Such employed movable bearings can be structured so that it prevents the transferring loss of the movement, but allows axial moments by stretching/twisting.

Regarding all alternative embodiments of the present invention as described hereinabove, the present mechanism is assembled to frames of other processing systems or to movable elements connected to such systems, and thus the automatic controls required during by the workpiece during operation is provided by other control units. The automatic control options of these control units based on data received from the present mechanism are given hereunder.

The angular positions of the main drive spindle or main drive motor are transmitted to the mechanism controlling units by means of pint or proportional sensors, and the proper automatic control function is applied.

When an electromotor is used as a drive motor, a signal proportional to consumed energy is transmitted to the control units by such sensors, and the pressure exerted on processed pieces by the working pieces are controlled by applying automatic control function on the drive actuator on the z axis.

The control of pressure on processed pieces can also be performed either by transmitting the linear position of actuators by point (head-center1-center2-end) or proportional sensors to the control unit, or by transmitting their position on the course (head-center1-center2-end) by point or proportional sensors to the control unit.

Automatic control is applied on the forces the terminal units are exposed to by means of stress sensors to be positioned to supporting points.

By connecting vibration sensors to be attached to required positions to the control units, a smooth operation is provided as a result of eliminating vibrations on the resonance frequencies by means of the automatic control to be applied to the main drive spindle or a constant speed operation is performed at resonance free region.

When this mechanism is operated by rotating around itself as a result of connecting this mechanism's frame to the main frame with rotating coupling elements, sensors, actuators, and fluid transferring hoses must be connected with tolerances between two such frames with a protective armor, the rotation angle must be restricted with the connecting bearings or the number of rotations must be controlled by the control unit.

The flow of external fluids transferred to this mechanism is controlled by external control units.

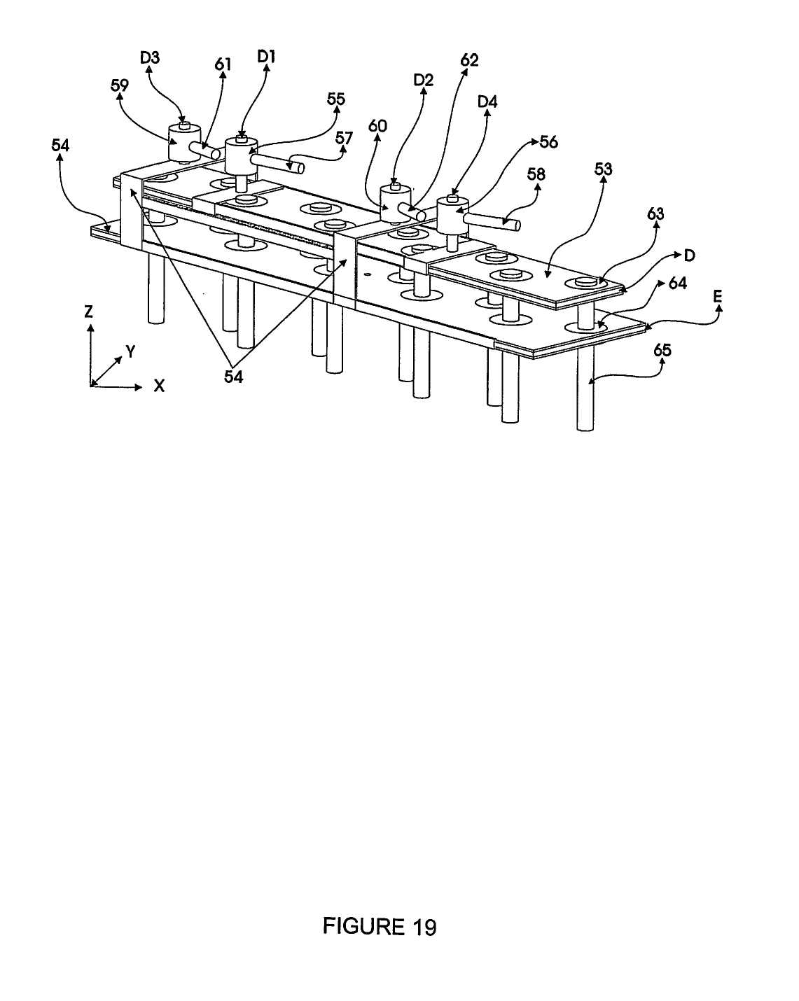

FIG. 19 gives a perspective view of a preferred embodiment mechanism comprising the double-plate multi final drive spindle under the present invention. Accordingly, two D points (D1-D4) are formed on a primary plate (53) and two primary drive transferring shafts (57, 58) are connected there at points C, the latter (57, 58) being driven by the same axially rotating shaft as the primary rotating bearings (55, 56). The positions of this drive transferring shafts on points A and B are calculated so that the diameters of ellipsoid movements to be transferred from such shafts to C points are identical, and their rotation angles synchronized. The movements of the eccentric bearing structures on points A and of the movable sliding bearing structures on points B on the Z axis must be kept restricted.

Two D points (D3-D2) are formed on a secondary (54) plate and two secondary drive transferring shafts (61, 62) are connected there at points C, the latter (61, 62) being driven by the same axially rotating shaft as the secondary rotating bearings (59, 60); and the ellipsoid movement on points A of these drive transferring shafts is received from a different axially rotating shaft as compared to the first one.

There are provided movable bearings (63, 64) assembled to equivalent points on x and y axes of the primary and secondary plates (53, 54) and final drive spindles (65) connected to each of them on the z axis. While these movable bearings (63, 64) can be structured so as to permit the axial rotation of the final drive shafts (65), they can also be produced from a flexible material such as rubber. Such flexible structure, however, does not permit movement losses on x and y axes.

By positioning primary and secondary plates (53, 54) apart on z axis, D and E points are obtained on final shafts. Since the ellipsoid movement's diameter and velocity formed at point A where the primary plate (53) is connected is different from the ellipsoid movement's diameter and velocity formed at point A where the secondary plate is (54) is connected, ellipsoid movement with different velocities and diameters can be obtained on such plates (53, 54). The total of the different movements at points D and R of final drive shafts (65) connected to such plates is transferred to point F at the final drive shafts (FIG. 28d).

There are also different methods to obtain different ellipsoid movements at point F. Regarding an alternative of these methods, the ellipsoid movement is formed as indicated above on one of such drive plates—primary plate (53) or secondary plate (54). The other plate can be connected to the frame by means of bearings (66, 67) structured so as to rotate internally or externally at two points D.

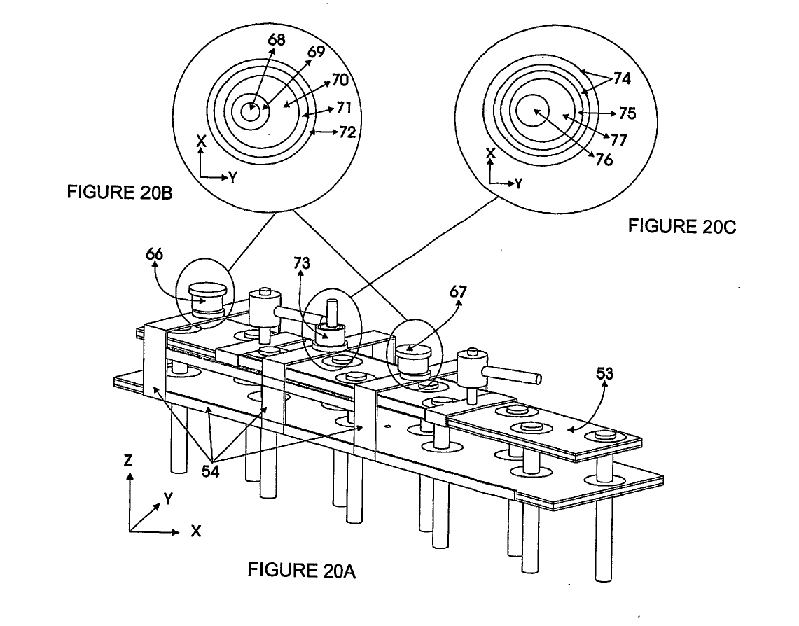

As seen in FIG. 20a, there are provided a shaft (68) with center D where these bearings are connected to the drive plate and a bearing rotating on this shaft, a spacer (70) on the outside of this bearing (69) having the inner bore center eccentric with respect to the outer diameter center, a rotating bearing (71) exterior to this spacer (70), and a connecting support (72) connected to the frame exterior to the bearing. With this assembly manner, the exterior connecting support (72) can make an ellipsoid rotation around the central shaft proportional to the eccentricity of the spacer (70) without rotating axially.

Driving of the related plate—primary plate (53) or secondary plate (54)—can be accomplished by various alternative embodiments. If such drive is provided by an axially rotating actuator, an axially rotating bearing (73) can be placed at point A with an eccentricity and angular position relative to the part in the middle of XY coordinates of both D points of the drive plate identical with those of other eccentrically rotating bearings (66, 67) connected to the drive plate. A support (74) of this bearing (73) connected the drive plate can be connected to the drive transferring shaft (76) of an axially rotating actuator that is connected to the frame with an included bearing (75) by means of an eccentric spacer (77) directly or with transferring elements. The center of the axially rotating shaft is the center of point A. The axial rotating transferred from the actuator to point A is transferred to the drive plate as an ellipsoid rotation with the eccentric rotating bearing (75) at point A, and such ellipsoid movement is obtained equally on all regions of this plate with the restriction of the ellipsoid bearings (66, 67) whereby the drive plate is connected to the frame. In other words, an ellipsoid movement is obtained at the drive plate as a result of obtaining an ellipsoid movement without an axial rotation relative to the actuator's shaft at the exterior support of the bearing resulting from the axial rotation of the shaft connected to the actuator.

In circumstances when multiple drive plates are connected in the x axes with axial bearings to the frame, the rotation angle of the axially rotation shafts (76) providing the axial motion to such plates must be synchronized to other axially rotating shafts and actuators so that the centrifugal effects of the plate motions are zeroed on the frame. When they receive the drives from the same actuator, the transferring elements shall not allow angular slipping, and the rotation angles of the axially rotating shafts are calculated and the positioning of the transferring elements are arranged so that such angles become synchronized.

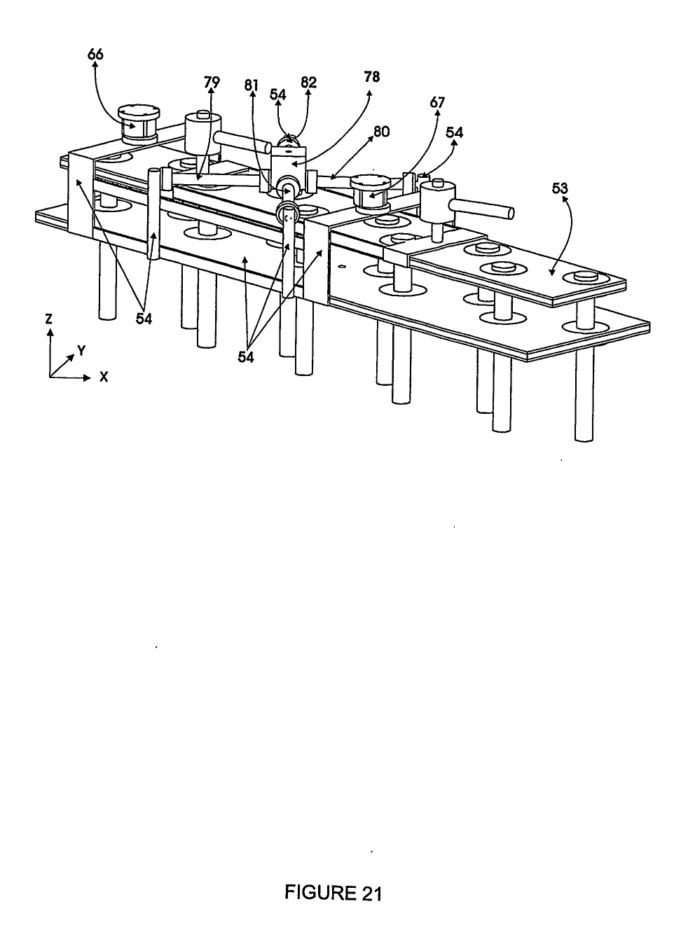

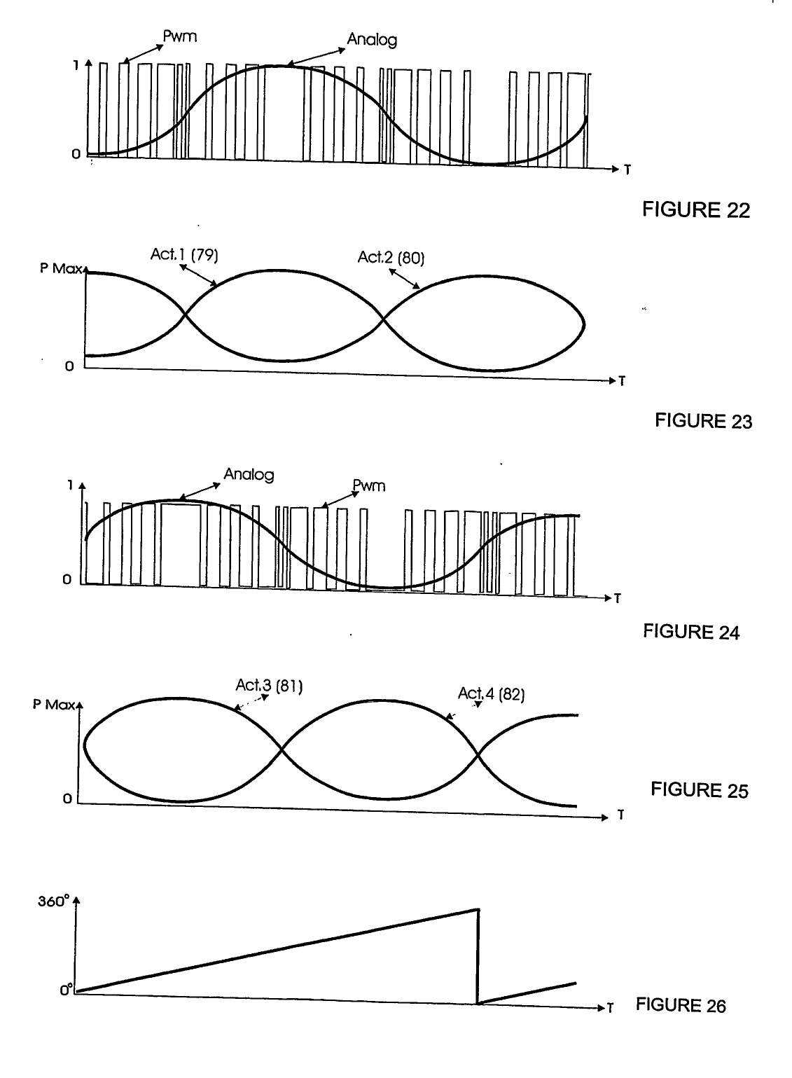

According to another alternative seen in FIG. 21 towards driving the related plate—primary plate (53) or secondary plate (54)—single or double effective linear actuators or actuators (79, 80, 81, 82) providing pulling force by shortening with fluid pressure are connected between the plate (54) and the support (78) connected to the frame. The number of actuators can be selected as three or more, provided that the positions of actuators on x and y axis between the plate and the frame are so that the angles of actuators to pull and push the plate are distributed equally to the angles of ellipsoid rotation.

Since these actuators (79, 80, 81, 82) operate with fluid pressure, the plate is moved relative to the frame by controlling the fluid amounts or pressures towards the actuators by means of flow/pressure control elements. Since the plate is connected to the frame with rotational bearings, the motion is shaped ellipsoidal with the restriction imposed by ellipsoid bearings. Fluid control elements can operate proportionally or by simply opening/closing.

When the numbers of actuators are four, the actuators are positioned with 90° differences to create a pulling force against each other. Each actuator is matched with the actuator that is 180° contrary. The pulling force of each such matched actuator (pressure illustrated in FIGS. 23 and 25) is controlled with one or more flow/pressure control element and as such control element is driven by control units in synchrony (FIGS. 74, 76). This control element has two differently pressurized fluid inlet and two differently controlled fluid outlet connections. Fluids are fed to the fluid inlets of both control element, one such fluid pressurized more than the other and such two fluids arranged independently from each other. When the fluid with a lower pressure is transferred to the actuator (79), the actuator is kept deactivated and thus avoided from lengthening and the drive plate is not freed. The force to provide the main drive is obtained by transferring the high pressure line to the other actuator (80). By limiting the actuators' strokes, plate and bearings are prevented from excessive pulling force. Rational or time-dependent controls are applied by the control elements in compliance with preordered sampled ellipsoid motion with the desired rotation speed of the driven plate. The control element divides such different pressures among other actuators integrated with a 180° difference (FIG. 23).

Ellipsoid movement is obtained on the plate (FIG. 26), once this connection and control setup is applied (FIGS. 24 and 25) to other identical actuator group (81, 82) positioned with a 90-degree phase difference from the ellipsoid rotation angle. When one extra or one apiece matched actuator group is attached to different regions of the drive plates, the fluid connections of actuators are matched to each other in line with the ellipsoid motion.

Control application can also be performed by taking positional data from the mechanical setup. With point or proportional sensors to be assembled on actuators or the frame, it becomes possible to detect the position of the plate. The equivalence of the angular velocity distribution at the 360° rotation of such ellipsoid movement is proportional to the number and features of position sensors. By comparing the drive plate's position with a desired position with the sensors and identical analog or digital comparison structure, the control section checks the control elements. When such control elements are equipped with proportional flow or proportional pressure features, the fluid flow amount towards the actuators is controlled in a digital or analog manner based on the structure of the control element. When such control elements are equipped with open/close functions, such fluid is transferred by controlling the open and closed period rates.

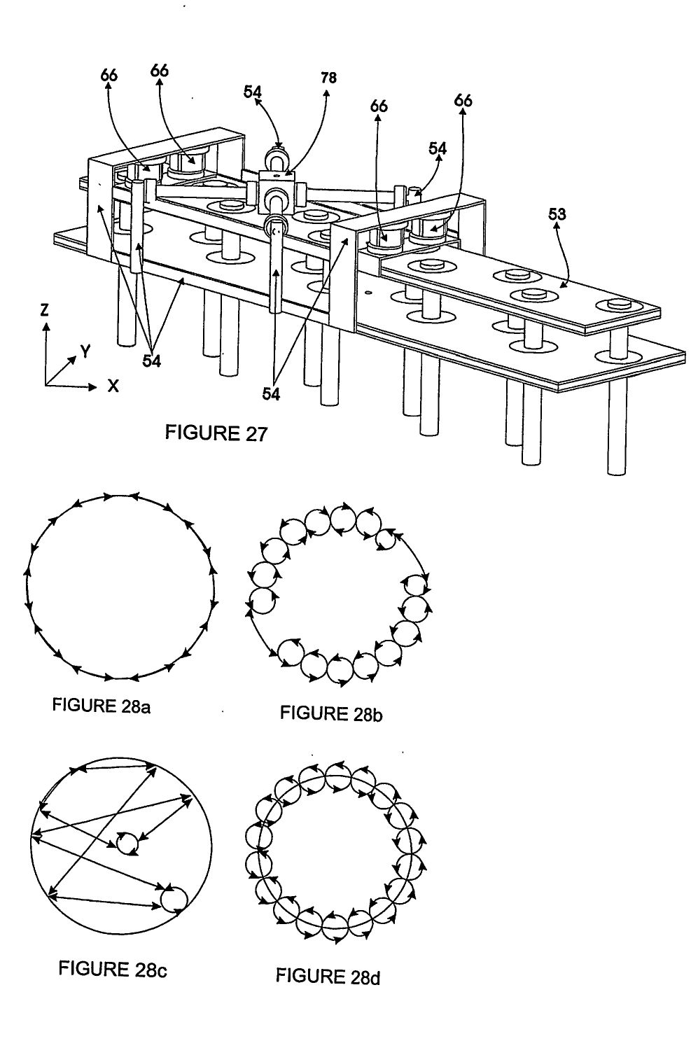

Regarding another method to obtain a different ellipsoid movement at point F, either with or without mechanical position sensors, as seen in FIG. 27, one of such drive plates (54) is fixed to the frame or the other (53) is connected to this plate with ellipsoid rotating bearings (66). The connection support (78) of actuators at the point of coupling is connected to the other drive plate (53). In the control application in this method, however, the total of both movements must be applied by a single control system.

If there is not a flexible connection element present in ellipsoid bearings (66), a forth and back movement is obtained on the orbit that is permitted by the bearings without a second ellipsoid motion formed (FIG. 28a). The number and size of this second movement is determined by the control units.

When the connection support connecting the ellipsoid bearings (66) to the drive plate (53) or some of the structural elements within itself are flexible, a second ellipsoid movement (FIG. 28b) becomes available in a degree determined or permitted by this flexible element, such movement being different from the first (as seen in FIG. 28a). This limit of such second ellipsoid movements shall be greater/on the rotation trace/diameter of the ellipsoid bearing, as permitted by the flexible connection element in the bearing.

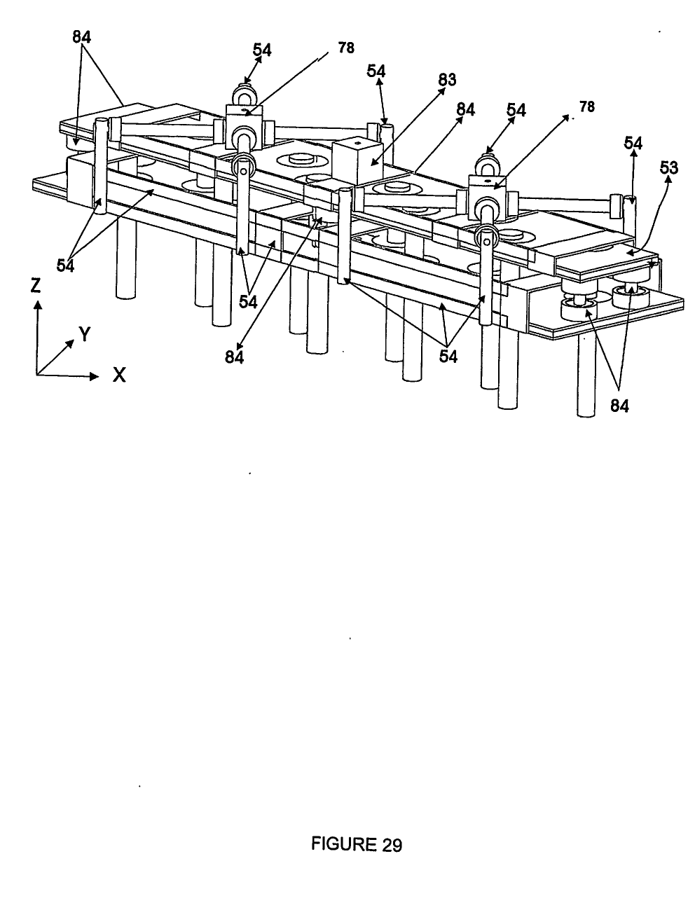

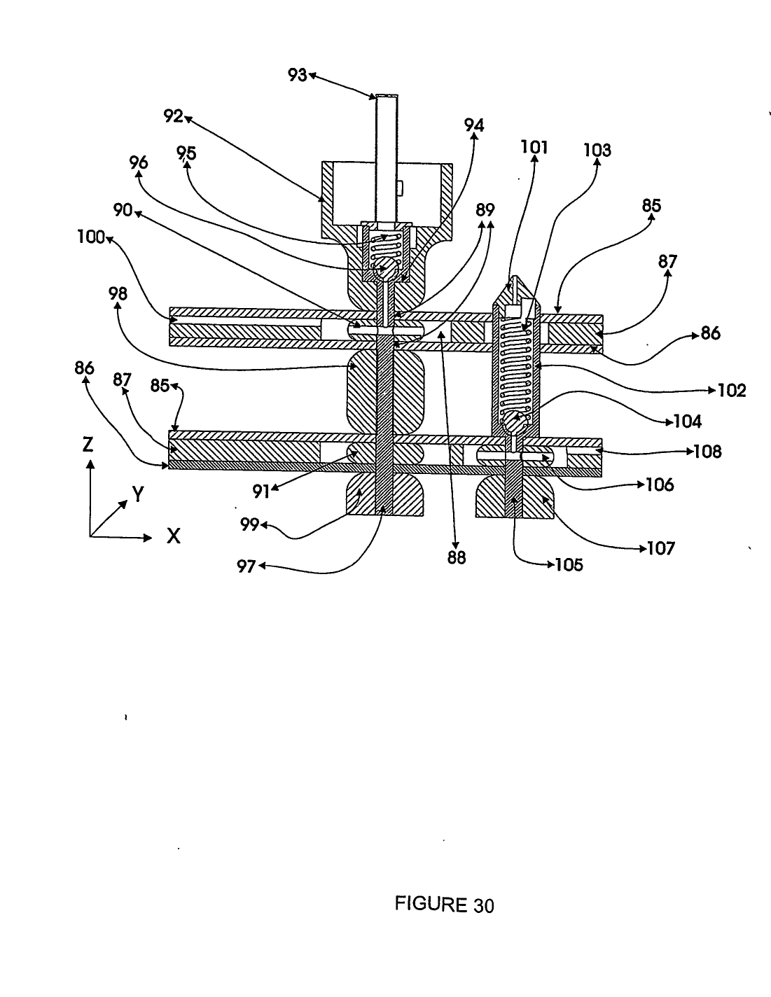

When one of such drive plates is fixed to the frame with a connection support (83) and with the common connection supports (78) of actuator groups as seen in FIG. 29, an ellipsoid movement is obtained within the limits of movable bearings (84) and actuators, provided that the other drive plate is connected to the former plate by means of movable bearings (84) to be assembled between such plates without the use of ellipsoid rotation bearings. Two or more equivalent actuator groups are assembled between such drive plates to provide the ellipsoid movement equal on the whole surface of the plate; so are they moved equally by the same control element. Therefore, by applying an equal ellipsoid movement simultaneously on two different points of such drive plates, the same ellipsoid movement is obtained on the entire regions of the plate.

Ellipsoidal motion combinations of the plate are obtained within the limits of the movable bearings (84) and the actuators in compliance with the preordered and sampled of the control system.

If position sensors to be positioned independently on x and y axis of the plates between such plates shall transmit data to the control system, the position of the drive plate is continuously controlled by the control system.

In order to absorb the centrifugal affects that such drive plates (53, 54) shall possibly create on the frame, fluid connections of actuators on the drive plates to be connected to the frame are reversed with respect to each other.

In case the driven plates (53,54), excluding the parts of frame and the primary drive spindle, are structured to move in XY axes and flexible in Z axis, active or passive pushing or pulling means are connected to those parts of the plates so that pressure is controlled in Z axis.

If the centers of movable bearings on x y axis on the final drive spindles are shifted on the x y axis relative to the other plate, the positions of F points on the final drive spindles to be assembled to these bearings, are brought to the x y axis proportional to the distance from the center of the movable bearings in plates. The workpiece is applied drives with different slopes (crossing from radial contact to axial contact) by final drive spindles positioned, in this manner. By coordinating or offsetting the movable bearings' center so that to conform the slope of the drive plates on the z axis to the surface form of workpieces, the movement limits of movable bearings and the movements of drive plates on the z axis are operated optimally. While such drive plates leans to the z axis, the position of the final spindle alters at these movable bearings and when the slope is increased, no field is left for an ellipsoid movement as the bearings reach their limits, thus once a predetermined slope is given to the drive plates, the bearings XY positions are arranged proportional with this predetermined slope.

When the frame couplings are performed by positioning eccentric bearings in the internal surfaces of primary and secondary drive plates, the coupling between the drive plates and the frame becomes T shaped and the plates form the upper part of such “T”. The regions of primary and secondary drive plates on the outer surfaces are not restricted. When the final drive spindles are positioned within movable bearings so as the lengths of such final drive spindles out of the drive plates are equalized and F points are formed on each drive plate, two F points are obtained on each final spindle and thus it becomes possible to make simultaneous operations on double surfaces or the operative terminal units are spared.

Whilst there are a number of application fields where such movement and control methods are employed, the following vehicle brushing units shall be disclosed hereunder as a preferred embodiment of the present invention.

The drive plates are preferably selected among flexible materials for such a cleaning oriented application under the present mechanism and such mechanism must be constructed so as to deliver fluids required for such cleaning purposes.

Such drives plates (87) embodied preferably from thermoplastic material compose elements with coatings on both surfaces with rubber/polyurethane elastomer based materials (85, 86)—these coatings function as supports at the same time—and fluid transferring channels thereon. The movable bearings where the final drive spindles are to be assembled are embodied on the drive plate. Regarding such movable bearing, there are provided a fluid passage orifice (8) on the central drive plate (87), one apiece flexible bearing with common centers on the surface coating of this drive plate (87), and spacers (90, 91) between such both surface coating (85, 86), having a longitudinal orifice opened on:the center and cylindrical surface (on the radial direction), with the edges beveled and functioning as an internal support and fluid transferring element. Although these spacers can appear as a part of the drive plates, they are a part of the final drive spindle. On one spacer (90) on the lower and upper movable bearings, an extra orifice is formed for the fluid transferring channel.

The final motion bar is composed of a combination of parts. It is composed on one end, an upper adapter (92) with a beveled corner facing the plate having a lock like cavity where cleaning brushes are to be attached and at the continuance of this cavity, an interior cavity where the spindle is to be attached; an punctured pipe (93) with a flexible structure having various orifices to transmit liquid to the brushes and a cylindrical bearing (94) where such pipe is assembled; a pushing spring (95) within such cylindrical bearing and a spherical valve (96) that said spring pushes; a shaft (97) with a chamfer at the tip, which is integrated into this cylindrical bearing, of which the interior is bored so as to open to the orifice in the punctured spacer on the primary drive plate, and which has a length reaching the lower plate at the end of the secondary plate; a spacer (90) with both edges beveled and having fluid transfer orifices in the movable bearing; a supporting piece (98) with both edges beveled and positioned between the plates where this shaft (97) passes; a spacer (91) with both edges beveled within the secondary movable bearing; and fastening element (99) tightening and fastening the whole structure and having a beveled edge against the plate. The brushing group, which is locked to the upper adapter in a detachable manner and, which is in a thermoplastic, fiber, sponge, etc. form, is a part of this final bar group. Circular cavities and projections are embodied on the surfaces of the upper adapter and intermediary supporting pieces contacting the polyurethane elastomer/rubber materials on the surfaces of the drive plates so as to tightly clutch them and prevent any slippage and liquid material leakage therefrom. The inner diameters of circular cavities (88) of supporting plates making up the movable bearings in drive plates and the outer diameters of the upper adapter (92) and the fastening piece (99) and other spacers (90, 91, 98) are proportioned so as to provide an ellipsoid motion and not to exceed the motion limits of rubber/polyurethane elastomer materials at the same time. The liquid provided by means of the channel in the drive plate (100) reaches directly the brush groups by means of the orifices on the pipe after passing through the valve mechanism that opens the fluid way at a certain pressure by means of the spacer. As a result of the tight contact of the brush elements to be assembled to the upper adapter's fastening piece to the body of the flexible fluid transferring pipe or as a result of assembling such brushes directly to such fluid transferring pipe, the losses in the ellipsoid motion to be transferred to the brushes at the foremost tips are reduced. The pipe, however, must be structured so that it shall not scratch the vehicle's surface when the pipe is left without a brush or it must be embodied with materials (felt, sponge, etc.) that shall not scratch such surface. When the ellipsoid motion of the drive plates is movable between such plates or not restricted at the ellipsoid bearings, the upper adapter or the spacers are made contact the drive plate by enlarging their diameters on their outer diameters at a certain distance from the drive plate in order to the restrict the diameter of the ellipsoid motion. This restriction processes can also be realized by adding movable bearing with restricted movements to various zones between the primary and secondary plates.

According to an alternative embodiment of the present invention, when said final motion spindle composed of a number of parts as indicated above is embodied in an integrated form so as to incorporate the spacers in plates and the double layer flexible bearings made up from flexible rubber-polyurethane elastomer material at the drive plates, it becomes adequate that such flexible bearing material is single layered for each drive plate. As a result of arranging the positions of such flexible bearing at the Z axis of the final bar proportionally to the primary and secondary drive plates, it becomes adequate to fasten them to the drive plates with washer like materials. When one section layer of the primary and secondary drive plates of is these flexible bearings are manufactured in an integrated manner so as to incorporate the supporting piece (98) on the primary plate (85) and other plate (85), it becomes possible to assemble the final bar to the drive plates with washer like materials and fasten to such integrated bearings by means of a fastening piece or to assemble it tightly into the orifice in the integrated bearings so as to provide the related fluid transfer to the part before such valve by means of flexible hoses. It is also possible to form each fluid transferring group independently on a single drive plate or to make them contact the main supporting hoses by means of transferring hoses without using such drive plates. In this condition, an annular rubber/polyurethane elastomer based material with an orifice in the center can be attached to a single surface of drive plates or between two plates to form a single drive plate and thus an movable bearing can be obtained by fastening them together with washers of suitable diameter, such washer having screwing orifices on both of its surfaces and bored at the center.

A spraying nipple is formed and contacted to such plates in order to deliver a second fluid to a surface to be cleaned. It is composed of a punctured piece (101) with a punctured piece at the tip and a cylindrical bearing (102) to assemble such piece; a pushing spring (103) within the cylindrical bearing and a spherical valve (104) that said spring pushes; a shaft (105) with a chamfer at the tip, having at the interior a hole which is open to the orifice at the punctured spacer at the secondary drive plate integrated to this cylindrical bearing and of which the length reaches the lower piece at the end of the secondary plate; a spacer (106) with both edges beveled having fluid transferring orifice within the movable bearing where such shaft is passed; and a fastening element (107) of which the edge facing the plate is beveled and which tightens the whole structure and fastens it to movable bearing. The liquid provided by means of the channel in the drive plate (108) reaches directly the vehicle's surface by means of the orifice at the nipple after passing through the valve mechanism that opens the fluid way at a certain pressure by means of the fluid spacer.

The passage orifice at the primary drive plate where this cylinder passes has a diameter so that the plate does not contact the cylinder during the ellipsoid motion. The orifice at rubber/polyurethane elastomer materials of both faces of the primary drive plate may differ according to purposes. When an ellipsoid motion is applied to the cylinder, it must have a diameter to contact the cylinder. The sizes of these spraying elements with a cylindrical structure must have the size and coordinates that allow them to pass through the primary drive plate and spray a surface with liquid from the intermediary spaces of the brushes.

The fluid transfer is realized by taking the fluid from other control elements with a flexible hose connection and by delivering it to the fluid transferring channels at primary and secondary drive plates.

In order to prevent such fluid from drain from such channels at the end of an operation, spherical valves with pushing springs are mounted on each fluid outlet part. This stopping mechanism opens only if pressurized fluid is applied to the channels to provide such fluid flow.

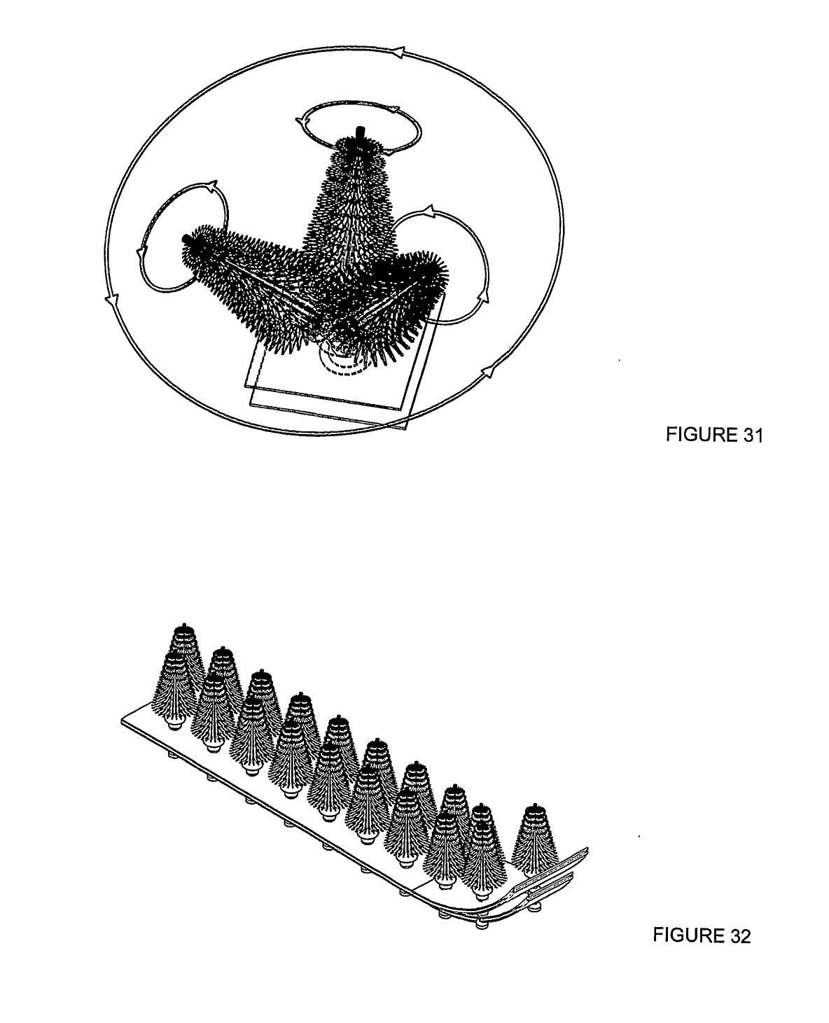

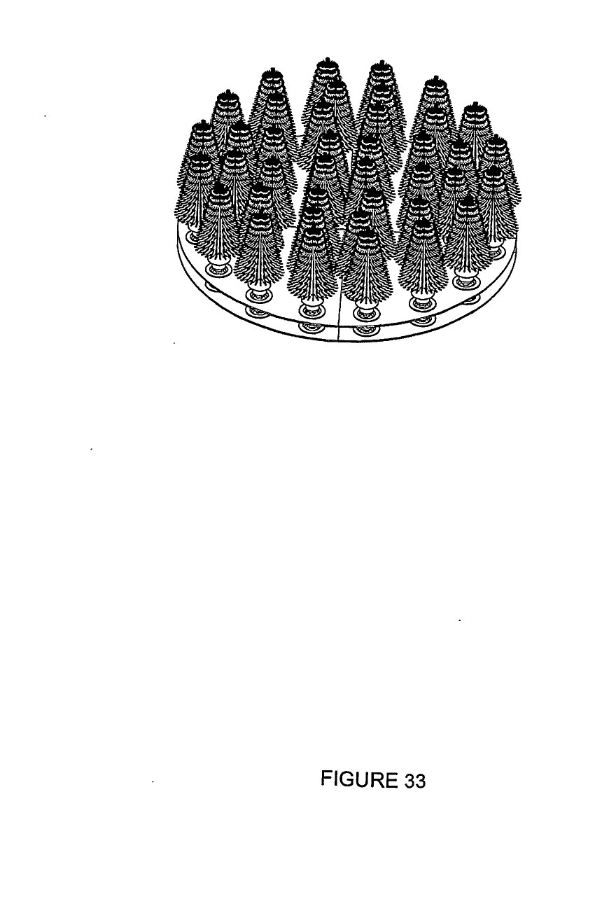

A brush embodied under these conditions is given in FIG. 31. The larger ellipsoid motion on the brush allows the brush on smooth or groovy surfaces to be cleaned, whereas the other smaller, but faster ellipsoid motion allows a relatively more efficient cleaning to be made. When the larger ellipsoid motion or both motions are realized by means of fluid actuators, a relatively more efficient is applied on groovy surfaces, since the larger motion contains the forward and backward motion components. The size, speed, and form of such motions are arranged according to the structures of materials making up such brushes. In order to ensure that the mechanical energy applied on vehicle surfaces does not convert to high heat, slippery cleaning chemicals are employed in brushes, they are followed by control systems, and the energy amount spent on brushes are checked. When position sensors and actuators activated with fluid pressure are used, the rates towards fluid pressure value provided to control elements and the ellipsoid speed are followed and the energy amount consumed on brushes are checked. By positioning pressure sensors to the surfaces of drive plate facing the brushes, the pressure of the brushes along the z axis are controlled by control units once the excessive mechanical movements of brushes exerts pressure to such sensors.

When it is required to dry such cleaned surfaces, such drive plates are formed by connecting to the punctured flexible pipe fluid transferring fiber-like elements in place of brushes to not to scratch such surfaces like fiber-felts, and by providing a direct transfer to the channel at the drive plate without using the valve mechanism at the drive spindle. Fiber-felt like elements contain a fibrous structure capable to transfer fluid towards said flexible pipe (93). By connecting a vacuum pump to be connected to the main frame to the channel at the drive plate, it becomes possible to vacuum and remove the fluids from the surfaces.

When it is required to polish such cleaned and dried surface, the final drive spindle is composed of a felt like material not to scratch such surface in place of the brush and pressure and heat is formed with mechanical movement on the surface. By connecting a hot air pump in place of said vacuum pump, it becomes possible to provide the surface with hot air.

When washing operations from such embodiments are applied on vehicles, trains, aircrafts, etc., significant advantages are obtained as compared to other axial rotating brushing methods.

In order to clean a vehicle's surface from front to rear, brushing groups are formed by grouping the drive plates where brushes are positioned at such vehicle's width by the use of the aforesaid methods. In order to allow such brushing group to perform a cleaning operation, the brushes must follow the surface by exerting a certain pressure thereto according to the structures. Thus such brush groups must be connected to the main frame with axial rotating and in a horizontal position with straight bearings movable on a vertical axis and be moved from the front to the rear or from the rear to the front of a vehicle by means of actuators driving them. By connecting a guide support, providing the back and forth movement of spraying nozzles fed with pressurized liquid from the main frame by means of flexible hoses at a point slightly exceeding the operative direction of brushes, together with the brush group to axially rotating frame bearing, and by moving it to the left and right, a preliminary cleaning is performed before brushing. For the lateral surfaces of the vehicle, such brushes are positioned vertically, and similar operations repeated. Regarding those circumstances where brush sizes are required to be small enough not to include mirrors, for example, when some regions of such vehicles like mirrors are cleaned, brush groups are formed with certain spaces in between them and in the region where such spaces are formed, one or two extra brushing units can be formed positioned so as to clean such mirror from below, top, and front. While such brush unit is moved along such vehicle, a side cleaning operation is performed as control units coordinate such spaced part according to such mirror.

The x-axis movement of the pressurized fluid spraying tip is provided with this guide support and the linear actuator positioned thereon. When the mobile carrier of the spraying nozzle at the guide support is activated on the z axis, the distance of the spraying nozzle to the vehicle's surface can be controlled. Therefore, while the spraying nozzle scans the vehicle's surface from right to left, its distance to the vehicle's surface can be altered. By attaching active ultrasonic/infrared scanning units to the part where such spraying nozzle is attached, and when such control units are reported accordingly, the actuator moving the carrier are controlled by control units on the x and z axis.

By forming such drive plates with a circular structure and by arranging such brushes in a circular manner as shown in the Figure, a proper structure is obtained in order to clean surfaces with circular forms such as rims and wheels of vehicles, and turbine motors. To clean such a rim, the brush group must be driven to frame with drive mechanisms that shall allow the brush group exerts a certain pressure to such rim. By fixing the vehicle's wheel with the control system, this group is moved from the frame to the wheel and removed from the wheel to the frame when the task is completed. By rotating the brush group after contacting it with axially rotating bearings and with the mechanical system providing this motion, various cleaning operations can be obtained. By transferring the pressurized fluid by means of flexible hoses from the frame to the spraying nozzle that is positioned on an outer periphery of one of the drive plates and that is directed towards the mudguard space, the interior of the mudguard of such vehicle can be cleaned once the brush group is axially rotated along the mudguard. When similar operations are performed by assembling said spraying nozzle on the tip of a movable arm to make such nozzle penetrate into a mudguard, it becomes possible to clean the interior of such mudguard section. It is also possible, however, to clean the vehicle wheels and rims with brush groups that are not circularly arranged.

This cleaning illustration described hereinabove is only one variation for such brushing unit; it is possible to realize different applications by forming such drive plates in different sizes.

1. A mechanism comprising a main drive spindle being driven by a power supply and rotatable axially-; at least one eccentric element being in communication with said drive spindle and producing eccentric motion; at least one bearing means surrounding the eccentric element; and at least one drive transmitting element being configured to perform an essentially linear movement which is transformed into an orbiting motion of a final drive spindle, one of the terminals of the drive transmitting element being connected to said eccentric bearing means (5) and the other terminal to the final drive spindle, the drive transmitting element passing through a drive transferring spindle bearing associated with a supporting piece connected by bearings to the main frame.

2. A mechanism according to claim 1, comprising at least one final spindle bearing connected to said final drive spindle and said drive transferring element.

3. A mechanism according to claim 1, further comprising a terminal unit comprising a bearing means supporting the terminal unit to be operative at the other end of said final drive spindle.

4. A mechanism according to claim 1, comprising a rocker bearing (16) providing the connection of the final drive spindle (8) to the main frame (2).

5. A mechanism according to claim 1, further comprising a bearing which is fixed to the main frame at a lower or upper side of the final spindle bearing, respectively, when the final spindle bearing is positioned to a point close to the upper or lower end of said final spindle.

6. A mechanism according to claim 1, comprising a spring provided on the lower side of said supporting piece and another supporting piece surrounding said spring so that said final drive spindle can displace on the axial direction.

7. A mechanism according to claim 1, wherein said bearing means can rotate on the radial direction with respect to the longitudinal axis of said main drive spindle.

8. A mechanism according to claim 1, further comprising a bearing lower end with a spherical formation provided on the lower end of said final drive spindle, and a sloped platform provided in a rotating manner on the main frame, the platform being in contact with said lower end so that said final drive spindle can displace on the axial direction.

9. A mechanism according to claim 8, further comprising a support being supported with springs, and the support being fixed to the spherically formed bearing lower end.

10. A mechanism according to claim 9, further comprising a final spindle joint provided between said support and said final drive spindle.

11. A mechanism according to claim 8, by further comprising a spring provided on the lower region of a straight sliding bearing carrying said final drive spindle.

12. A mechanism according to claim 1, further comprising a flexible tube means provided on the lower side of said final drive spindle and an air inlet for supplying air to said tube means so that said final drive spindle can displace on the axial direction.

13. A mechanism according to claim 1, further comprising an actuator means positioned on the lower part of said final drive spindle so that said final drive spindle can displace on the axial direction.

14. A mechanism according to claim 1; further comprising an actuator means connected to a support with one end supporting said final drive spindle so that said final drive spindle can displace on the axial direction.

15. A mechanism according to claim 1, further comprising a connection element driven by the drive transferring spindle, said final drive spindle being provided by rocker bearings onto the connection element for forming a group; and a group joint connected to the connection element for connecting a secondary group to the group, said final drive spindle being also supported by rocker bearings to the piece lengthened from the frame element.

16. A mechanism according to claim 15, further comprising a bar joint, a bar, and an actuator means driving said bar, said bar joint being connected to the connection element of said secondary group so that said secondary group can rotate around the group joint.

17. A mechanism according to claim 1, further comprising an adapter support connected to the terminal unit bearing.

18. A mechanism according to claim 17, wherein said adapter support comprises key channels or threads providing the connection of said adapter support to said final drive spindle.

19. A mechanism according to claim 1, wherein the mechanism is driven by a single drive transferring spindle, when said final drive spindle is provided multiply.

20. A mechanism according to claim 1, comprising multiple eccentric elements connected to said main drive spindle, multiple drive transferring spindles connected to this eccentric elements, and multiple final drive spindles connected to such spindles.

21. A mechanism according to claim 1, further comprising a threading group positioned on the lowest position of said main drive spindle.

22. A mechanism according to claim 3, comprising piping means to provide fluid to said terminal unit bearing.

23. A mechanism according to claim 22, comprising openings embodied to enter said piping means into said adapter support.

24. A mechanism according to claim 1, wherein the mechanism is applicable for a group consisting of cleaning means, soil processing means, construction means, solid and fluid material orienting means.

25. (canceled)

26. A mechanism according to claim 1, wherein said drive transmitting elements comprise at least one primary drive transferring element and at least one secondary drive transferring element, said primary drive transferring element having one terminal connected to said bearing means and the other terminal to a primary plate such that the linear movement of the primary drive transferring element is transformed into an orbiting motion of the primary plate, and said secondary drive transferring elements being configured to perform an essentially linear movement and being connected to a secondary plate, the linear movement of the secondary drive transferring element(s) being transformed into an orbiting motion of the secondary plate (54), and at least one final drive spindle (65) which is supported by the primary plate (53) and the secondary plate (54) in a movable or flexible manner (63, 64), and said secondary plate (54) whereby the final drive spindle (8) produces orbiting movement.

27. A mechanism according to claim 26, wherein said drive transferring shafts, connected to the primary plate, are driven by the same axially rotating shaft, the drive transferring shafts, transferring identical ellipsoid movements to the primary plate, and secondary drive transferring shafts, connected to the secondary plate are driven by the same axially rotating shaft, the drive transferring shafts (61, 62) transferring identical ellipsoid movements to the primary plate.

28. A mechanism according to claim 26, wherein the movable or flexible support is achieved by rocker bearings comprised by said primary and secondary plate and supporting each said final drive spindle.

29. A mechanism according to claim 26, wherein said at least one final drive spindle is driven by both the primary plate (53) and the secondary plate (54).

30. A mechanism according to claim 1, wherein said drive transmitting elements comprise at least one primary drive transferring element and at least one secondary drive transferring element, said primary drive transferring element having one terminal connected to said eccentric bearing means and the other terminal to a primary plate such that linear movement of said primary drive transferring element is transformed into an orbiting motion of the primary plate, and further comprising one axially rotating bearing connected to a secondary plate and to the main frame; at least one ellipsoid bearing connected to said secondary plate and to the main frame; and at least one final drive spindle supported by the primary plate and the secondary plate in a movable or flexible manner, and said secondary plate, whereby the final drive spindle produces orbiting movement.

31. A mechanism according to claim 30, wherein said drive transferring shafts connected to the primary plate are driven by the same axially rotating shaft, the drive transferring shafts transferring identical ellipsoid movements to the primary plate.

32. A mechanism according to claim 30, wherein said at least one ellipsoid bearing comprises a spindle, a bearing rotating on the spindle, an eccentric spacer positioned externally to the bearing, a rotating bearing positioned externally to the spacer, and a connection support being positioned externally to the rotating bearing and connected to the main frame.

33. A mechanism according to claim 30, wherein said axially rotating bearing comprises a drive transferring spindle connected to an actuator, an eccentric spacer connected to the spindle, a rotating bearing positioned externally to the spacer, and a support connected to the drive plate.

34. A mechanism according to claim 1, wherein said drive transmitting elements comprise at least one primary drive transferring element and at least one secondary drive transferring element, said primary drive transferring element having one terminal connected to said eccentric bearing means and the other terminal to a primary plate such that the linear movement of said primary drive transferring element is transformed into an orbiting motion of the primary plate, and at least one support being connected to a secondary plate and to the main frame by means of a number of actuators; at least one ellipsoid bearing connected to the secondary plate and to the main frame, and at least one final drive spindle supported by the primary plate and the secondary plate in a movable or flexible manner, and said secondary plate, whereby the final drive spindle produces orbiting movement.

35. A mechanism according to claim 34, wherein said actuators are driven by single or double impacted linear or fluid pressure.

36. A mechanism according to claim 34, wherein, when said actuators are driven by fluid pressure, the fluid pressure and fluid amounts fed to the actuators are controlled by control elements featuring on/off or proportional control.

37. A mechanism according to claim 34, further comprising point or proportional sensors positioned on the actuators or the frame to provide said control elements with control data.

38. A mechanism according to claim 34, wherein said at least one ellipsoid bearing comprises a spindle, a bearing rotating on the spindle, one eccentric spacer positioned externally to the bearing, a rotating bearing positioned externally to the spacer, and one connection support being positioned externally to the rotating bearing and is connected to the main frame.

39. (canceled)

40. (canceled)

41. (canceled)

42. (canceled)

43. A mechanism comprising a main drive spindle being driven by a power supply and rotatable axially; at least one eccentric element being in communication with the main drive spindle and for producing eccentric motion; characterized by comprising at least one bearing means surrounding the eccentric element; a primary plate connected to the main frame, at least one support connected to the main frame and connected to a second plate, the mechanism being driven by means of a number of actuators; at least one rocker or ellipsoid bearing providing the connection of said secondary plate and said primary plate, a support connecting one of the plates, the support connected to the main frame, and at least one final drive spindle, which is supported in a flexible or movable fashion by said primary plate and said secondary plate, whereby the final drive spindle produces plurality of motion combinations.

44. A mechanism according to claim 43, further comprising point or proportional sensors positioned on the actuators or the frame to provide said control elements with control data.

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. A brushing unit for cleaning purpose comprising a mechanism according to claim 26 and further comprising plates produced preferably from thermoplastic material coated preferably with elastomer coatings having supporting functions, holes provided on said movable plates for rocker bearings, a supporting piece provided within the holes, and positioned between said drive plates.

61. A brushing unit according to claim 60, further comprising a spindle passing through the openings provided along said drive plates, said spacers, and said supporting piece and accommodating at its tip a cylindrical bearing, a channel provided substantially along the vertical axis of said primary drive plate up to the hole, another hole provided to said spacer, and an space having a “T” shape and the space being provided in the spindle and wherein the cylindrical bearing where the end of said “T” shaped opening is extending comprises a spring and a spherical valve in communication with this spring, and an upper adapter accommodating said cylindrical bearing and a flexible pipe positioned on the extremity of said cylindrical bearing and optionally an additional fluid supplying element comprising a spindle, a cylindrical bearing positioned on the terminal of this spindle, a spherical valve positioned within this cylindrical bearing, and a spring that said spherical valve is connected thereto.

62. A brushing unit according to claim 61 comprising a liquid spraying piece provided on the terminal of said cylindrical bearing.

63. A brushing unit according to claim 61, further comprising fiber-felt like elements for use drying clean surfaces and a vacuum pump in connection with said fiber-felt like elements for vacuuming fluids remaining on said surfaces, said fiber-felt like elements being fibrous and capable of transferring fluid towards said flexible pipe connected thereto.

64. A brushing unit according to claim 63, wherein a hot air blower is employed in place of said vacuum pump and that heat-resistant fiber-felt like elements are positioned in order to polish said cleaned surface.

65. A brushing unit according to claim 60, wherein said plates are produced preferably from thermoplastic material coated with elastomer coatings for supporting purposes so as to define an integrated structure and further comprising a support piece, which is provided within the holes opening into said drive plates for flexible bearings and provided between said drive plates, a layer of the parts of said flexible bearings at primary and secondary plates assembled with washer like materials to the drive plates; the final spindle being fixed to the integrated bearings by means of a fixation element or assembled into a hole within the integrated bearings in a tight-engaging manner and flexible hoses being provided for fluid transfer to a point before said valve for cleaning purposes, and an annular rubber/polyurethane elastomer based material with a hole at the center fastened to the single surfaces of drive plates or between two plates forming a drive plate enabling a rocker bearing to be obtained by tightening them with proper-diameter washers with a hole in the center and screwing holes on both surfaces.

66. A mechanism according to claim 43, wherein said actuators are driven by means of a single or double impacted linear or fluid pressure.

67. A mechanism according to claim 43, wherein, when said actuators are driven with fluid pressure, the fluid pressure and fluid amounts fed to the actuators are controlled by control elements featuring on/off or proportional control.

68. A method for producing orbiting movement, comprising the steps of—rotating an axially rotating main drive spindle, converting the axial rotation into an eccentric motion by means of an eccentric element connected to said main drive spindle, converting the eccentric motion essentially to linear motion by means of a drive transferring spindle connected to one end of said eccentric element, and—transferring the linear motion to the final drive spindle connected to the other end of said drive transferring spindle and thus orbiting this drive spindle, wherein the drive transmitting element passing through a drive transferring spindle bearing—associated with a supporting piece connected by bearings to the main frame, whereby the final drive spindle produces orbiting movement.
